(19) United States
(12) Patent Application Publication
(10) Pub. No.: US 2022/0147988 A1
(43) Pub. Date: May 12, 2022

(54) CREATING A SMART CONTRACT ON A BLOCKCHAIN LEDGER

(71) Applicant: SANGROVE, INC., New York City, NY (US)

(72) Inventors: Tatiana ALEXA, Chichester, NY (US); Stan MASHOV, Brooklyn, NY (US)

(73) Assignee: SANGROVE, INC., New York City, NY (US)

(21) Appl. No.: 17/586,466

(22) Filed: Jan. 27, 2022

Related U.S. Application Data
(63) Continuation-in-part of application No. 16/549,313, filed on Aug. 23, 2019.
(60) Provisional application No. 62/721,762, filed on Aug. 23, 2018.

(51) Int. Cl. G06Q 20/38; G06Q 30/06

(52) U.S. Cl. CPC G06Q 20/38215; G06Q 30/0637; G06Q 20/3825; G06Q 20/3827

(57) ABSTRACT

The present disclosure relates to systems, non-transitory computer-readable media, and methods for a secure way of new products release, analyzing and measuring products demand, and tracking purchases for a product campaign prior to manufacturing. In particular, in one or more embodiments, the disclosed systems create a smart contract between a single seller and multiple buyers. The smart contract is recorded in a blockchain ledger, which is publicly available and difficult or impossible to modify after being recorded.

### REFERENCE TO OTHER APPLICATIONS

This is a continuation-in-part patent application of co-pending U.S. Provisional patent application Ser. No. 16/549,313, filed on Aug. 23, 2019, and entitled “GREEN-LIGHT CAMPAIGN™ SYSTEM AND METHOD,” which claims priority to U.S. Provisional Patent Application No. 62/721,762 filed on Aug. 23, 2018, entitled “SANGROVE PLATFORM,” both of which are hereby incorporated by reference in their entirety for all intents and purposes by this reference.

### BACKGROUND

Recent years have seen significant improvements in the measurement of the consumer demand and readying the launch and production of new products. For example, conventional systems can utilize the communication capacity of the Internet to perform showcasing of new products, collecting buyers' reviews, ratings, and so-called likes on products and product designs. Sellers of products may describe their product on an online platform, and prospective buyers may write reviews, likes, ratings, and even donate money to the seller to produce the product. To illustrate, conventional systems may facilitate a marketplace where a buyer may essentially donate money to the seller on the hope that the seller will produce the advertised product (e.g., crowdfunding).

Although conventional systems can connect buyers and sellers, such systems have a number of problems in relation to accuracy, efficiency, and flexibility of operation. For instance, conventional systems do not allow for any specific legal commitment between the buyer and the seller. Specifically, conventional systems rely on the diligence of the seller to produce and ship the product to the buyer. This may allow an unscrupulous seller to take the buyer's money and not provide a product, change the product specifications, change the product price, or change any other aspect of the agreement with the buyer.

Conventional systems may create a limited, inaccurate, and/or inaccessible record of the terms of the agreement. This lack of record may reduce the accuracy of the agreements and the efficiency of enforcement of any agreements the buyers and seller enter into. In the event of a second seller attempting to promote the same product as a previous seller, this lack of a record results in cumbersome intellectual property enforcement operations.

These along with additional problems and issues exist with regard to conventional online systems connecting sellers with buyers in order to launch and produce new products.

### BRIEF DESCRIPTION OF THE DRAWINGS

The detailed description provides one or more embodiments with additional specificity and detail through the use of the accompanying drawings, as briefly described below.

FIG. 1 shows an overall diagram of an embodiment of the present disclosure.

FIG. 2 shows a flowchart of the system platform embodiment of the present disclosure.

FIG. 3 shows a flowchart of blockchain technology in an embodiment of the present disclosure.

FIG. 4 shows an example blockchain formation in an embodiment of the present disclosure.

FIG. 5 shows an example blockchain workflow in an embodiment of the present disclosure.

FIG. 6 shows an example smart contract workflow in an embodiment of the present disclosure.

FIG. 7 shows a platform embodiment of the present disclosure.

FIG. 8 shows an example aggregation software engine in an embodiment of the present disclosure.

FIG. 9 shows a chart concerning enrollment by a brand, buyer. and agent on an embodiment of the platform.

FIG. 10 shows an example graphical user interface in an embodiment of the present disclosure.

FIG. 11 shows an example system embodiment of the present disclosure.

FIG. 12 shows a flowchart of a green-light Campaign™ event embodiment of the present disclosure.

FIG. 13 shows a flowchart of a green-light Campaign™ event embodiment of the present disclosure.

FIG. 14 is a representation of a product tracking system embodiment of the present disclosure.

FIG. 15 is a representation of a campaign manager embodiment of the present disclosure.

FIG. 16 is a representation of a blockchain ledger embodiment of the present disclosure.

FIG. 17 is a representation of a blockchain ledger embodiment of the present disclosure.

FIG. 18 is a representation of a blockchain ledger embodiment of the present disclosure.

FIG. 19 is a representation of a campaign flow diagram embodiment of the present disclosure.

FIG. 20 is a flowchart of a product tracking system embodiment of the present disclosure.

FIG. 21 is a flowchart of a product tracking system embodiment of the present disclosure.

FIG. 22 is a flowchart of a token generation system embodiment of the present disclosure.

FIG. 23 is a representation of a computing system embodiment of the present disclosure.

### DETAILED DESCRIPTION

This application is directed to systems and methods for securely and publicly tracking a release (e.g., a first release) of one or more products or designs, as well as any purchases, and/or their cancellations in the event of insufficient demand for a Brand (e.g., a product designer, Brand company, Manufacturer, Seller). Releasing a new product may be associated with uncertainties, particularly regarding the amount of products to manufacture and sell. In accordance with aspects of the present disclosure, a manufacturer may initiate a product campaign, in which the manufacturer may submit details of the product to a campaign server. These details may include a product description, pricing, a minimum order quantity (MOQ). The campaign server may create a blockchain ledger, with an initial block in the chain being directed to the details of the product. The blockchain ledger includes a smart contract identifying terms and conditions for the sale or pre-sell of the product. Buyers may visit the campaign server to review the product. A buyer that desires to purchase the product may submit a purchase order, including a purchase quantity. The campaign server may update the blockchain ledger with the buyer's information, including the purchase quantity. The blockchain ledger may be updated for each buyer that submits a purchase order to the campaign server. When the campaign is over, and in particular if the minimum order quantity has been reached, the campaign server may execute the contract created on the blockchain ledger, which obligates the seller to manufacture and ship the product, and the buyer to purchase the product.

In some embodiments, a purchase logging method includes receiving a request from a seller to initiate a product campaign to manufacture and/or distribute a product. A campaign server creates a blockchain ledger for the product campaign. The campaign server adds to the blockchain ledger a smart contract having terms and conditions that outline the performances and obligations of the seller and the buyer of the product. The terms and conditions include an MOQ, which is the minimum quantity of units of the product that are ordered before the seller begins manufacturing and/or distributing the product. The campaign server receives a first request of a plurality of requests from a first buyer of a plurality of buyers to purchase the product. The first request includes a first purchase quantity. After the campaign server receives the first request, the campaign server updates the blockchain ledger with details from the first request. The first update to the blockchain ledger contractually binds the first buyer to perform the first request if the terms and conditions of the smart contract are satisfied.

In accordance with embodiments of the present disclosure, the campaign server may allow a single seller to provide a product to multiple buyers. The campaign server may provide a platform for a seller to describe their product and for buyers to review the product details. Buyers may place orders for the product on the platform. In some embodiments, the seller may be offering a potential product (e.g., a product that has not been manufactured yet). When the buyers choose to purchase the product, they submit a purchase order through the campaign server. If a sufficient number of products (e.g., the MOQ) are ordered (by any number of buyers), the campaign server may instruct the seller to begin manufacturing and/or distributing the product. In this manner, the seller may receive confirmation that it will sell the MOQ of the product, and the buyer has an indication that the product is in demand.

The records of the product and the sales of the product may be recorded on a blockchain ledger. As discussed herein, a blockchain ledger uses blockchain technology to create a public and permanent record of the sale of the product. Each block in the blockchain ledger may be used to record details of the product, terms and conditions of the sale, quantities purchased, and so forth. The blockchain ledger may include a smart contract. The smart contract may include terms and conditions of the sale, including obligations of the seller to the buyer, obligations of the buyer to the seller, minimum order quantities, pricing, delivery terms, timelines, and so forth. The smart contract may be an active document, and may be updated as the blockchain ledger is updated, including with each purchase from a buyer and/or based on modifications by the seller.

The purchase tracking system provides many advantages and benefits over conventional systems and methods. For example, by creating a blockchain ledger of purchase orders of the product, the purchase tracking system improves the accuracy and accessibility of purchase records relative to conventional systems. Specifically, because a blockchain ledger requires verification of each and every new block, hidden changes to the smart contract, product details, changes to the terms and conditions, and so forth are not possible. Furthermore, all blocks on the blockchain ledger are publicly available. Such immutability and accessibility improve the availability of the details of the purchase order for both the buyer and the seller. This may help to protect both the buyer and the seller from undesired and/or unagreed-to changes to the smart contract.

In some embodiments, the purchase tracking system may allow the buyer to determine their impact on the product. For example, a manufacturing process may have a particular ecological impact, such as a carbon footprint, amount of waste material, type of waste material, chemical releases, and so forth. The ecological footprint may be stored in the blockchain ledger. The buyers, upon review of the product campaign and the blockchain ledger, may determine the ecological impact of their purchase and its manufacturing. The sellers may also be able to determine the ecological impact of manufacturing and producing the product. In some embodiments, the buyers and/or sellers may be able to determine the impact of not executing the smart contract. This may allow a buyer or seller to determine the total impact of the product using independent, transparent, and difficult to alter blockchain ledgers.

In accordance with embodiments of the present disclosure, the blockchain ledger may further provide the benefit of creating a legally binding agreement between the seller and the purchaser. When the seller offers the product for sale and the buyer provides a purchase order, a contract is formed between the seller and the buyer. The seller may place conditions on the execution of the contract, such as an MOQ, price, shipping location, and so forth. As long as the buyers collectively meet the conditions for executing the contract, the seller and the buyer will be legally bound. Because, as discussed above, the blockchain ledger provides an unchanging and publicly available record of the contract, this may help to remove ambiguity regarding the presence and/or contents of a contract.

In some embodiments, the blockchain ledger may further provide the benefit of allowing a seller to provide a record of first use of intellectual property associated with the product. This may allow campaign manager to easily resolve notice-and-takedown disputes. For example, the seller may upload intellectual property documentation related to the product, such as a picture, a hash of a picture, description, and so forth. If another seller offers for sale the same product (or a product that utilizes the same design or other intellectual property), the first seller may request that the campaign server take down the second seller's product. This notice-and-takedown process may be streamlined using the record on the blockchain ledger.

As illustrated by the foregoing discussion, the present disclosure utilizes a variety of terms to describe features and advantages of the purchase tracking and demand and environmental impact measurement system. Additional detail is now provided regarding the meaning of such terms. For example, as used herein, the term “blockchain” refers to blockchain protocol. Specifically, blockchain protocol creates a growing list of records, called blocks connected with a cryptographic connection. Each subsequent block may include a record of the previous block, a timestamp, and any additional information that is added to the block. Because each block includes a record of the previous block, modifications to any previous blocks are difficult or impossible without amending each subsequent block in the chain.

A “blockchain ledger” may be a list of records connected using blockchain protocol. For example, a blockchain leger may include the offer for sale, the terms and conditions of a sale, the purchase order records from buyers, and so forth, for a product. In some embodiments, the blockchain ledger may be associated with a single product. In some embodiments, the blockchain ledger may be associated with a plurality of products.

A “product block” may be an individual block of a blockchain ledger that is associated with a seller's product. The product block may include information about the product, including the product ID, the product description, an IP description, the seller ID, product price, the terms and conditions of the contract, the MOQ, any other product information, and combinations thereof. The product block may be updated on the blockchain ledger with each purchase order from a buyer, adjustments to the terms and conditions.

In accordance with embodiments of the present disclosure, a “smart contract” may be a contract that is formed between a seller and a buyer encapsulated in the blockchain ledger. The smart contract may include terms and conditions that are set by the seller at the start of the campaign. When each buyer submits a purchase order, the buyer is added to the smart contract, committing the seller to produce the product and the buyer to pay the seller for the product. The smart contract may include one or more execution conditions, such as an MOQ. If the execution conditions are not met (e.g., if the MOQ is not ordered), the smart contract is not binding on the buyer or the seller. If the execution conditions are met (e.g., if buyers order the MOQ of the product), the smart contract may be binding on both the buyer and the seller.

As used herein, a “product campaign,” or more simply, “campaign,” may be a series of actions that occur over a period of time and are associated with selling or pre-selling of a product. The product campaign may be managed by a campaign manager at the campaign server. The campaign may be hosted by the campaign manager, and include the description of the product, the terms and conditions of the sale, the MOQ, any other element of the product campaign, and combinations thereof. In some embodiments, a “sales event,” or more simply, “event,” may include a series of campaigns that are associated with a single seller. In some embodiments, the sales event may include shared terms and conditions, shared order quantities, shared economies of scale, and so forth.

As used herein a “minimum order quantity,” or “MOQ,” may be the minimum number of units of a product ordered. The MOQ may be set by the seller. In some embodiments, the MOQ may be the minimum number of units of the product that the seller may sell for a particular campaign or event to be profitable. In some embodiments, the MOQ may be met by a group of buyers. In some embodiments, the MOQ may be met by a single buyer. In some embodiments, the MOQ may include an order increment (minimum-size product order), which may be the smallest order that a buyer may place. This order increment may be based on production lines, shipping and handling, and so forth.

As used herein, a “seller” may be a seller of a product in a campaign. In some embodiments, the seller may be the manufacturer of the product. In some embodiments, the seller may be a wholesale distributer of the product. The seller may be responsible for providing the product ordered by the buyer to the buyer under the terms and conditions of the sale. In some embodiments, the seller may not begin manufacturing the product until any execution conditions of the smart contract are met, such as the MOQ being ordered by buyers. As discussed in further detail herein, the seller may initiate a product campaign, set the terms and conditions of the campaign, set the price, upload any IP protection material, set any other elements of the smart contract, and combinations thereof.

As used herein, a “buyer” may be a buyer of a product in a campaign. In some embodiments, the buyer may be a retailer, a consumer, a distributer, a professional buyer, any other buyer, and combinations thereof. In some embodiments, the buyer may review product information during a product campaign and place one or more purchase orders for the product. The purchase order may include a purchase quantity, or the number of units of the product to be purchased, any proposed modifications to the smart contract, any other purchase elements, and combinations thereof.

Embodiments of the present disclosure provide for a system, method, and computer readable apparatus or medium having computer software instructions thereon, and computer software program app (application which can run on a portable computing device such as a mobile phone, tablet) for a business-to-business (B2B) and/or business-to-business-to-consumer (B2B2C) and/or direct-to-consumer (D2C) platform using blockchain-based smart contract technology to connect brands with buyers and by pooling resources to allow for only the best product designs to go to production stage, with quantities of products to be manufactured defined by measured demand. Embodiments of the present disclosure utilize an electronic account or wallet to effect the surety-type partial pre-payment and final payment for an order, utilizing distributed ledger technology. Embodiments of the present disclosure utilize an electronic account or wallet to effect the surety-type partial pre-payment and final payment for an order, and recordation of orders and payments, without utilizing blockchain technology.

Embodiments of the present disclosure utilize blockchain smart contract technology, which provides for security of records; such that records once in the blockchain cannot be altered in the chain history and blockchain smart contract technology creates a public record thus helping to promote the new product campaign.

Embodiments of the present disclosure provide for a system, method, and computer readable apparatus or medium having computer software instructions therein, and computer software program app (application which can run on a portable computing device such as a mobile phone, tablet) comprising one or more of the various features described herein.

Embodiments of the present disclosure provide for an optimization of the disconnected and fragmented processes currently used in commercial settings. Embodiments of the present disclosure utilize blockchain based technology to reduce what can be a copious amount of paperwork and eliminates the need for third-party verification. Such embodiments allow for various parties to connect securely to the transaction and optimizes numerous disparate processes, thus providing an easier system to bring new products to consumers. Embodiments of the present disclosure provide for improved processes which are sustainable and eliminate unnecessary waste and overproduction by pre-selling product designs and producing products that are demanded by buyers.

Embodiments of the present disclosure provide for the brand companies and buyers to pool resources by combining orders. For clarification, a brand company is first a product designer, but can also be the manufacturer or the supplier. Embodiments of the present disclosure provide a computer software based platform which causes current technology to be improved by providing a more efficient communication system directly capturing buyer's demand for products. Effectively, business transactions and processes are made efficient, cohesive, and more transparent than current processes.

Embodiments of the computer software based platform, allow for a buyer to pool resources, act as a business catalyst, and all while using a transaction optimization engine for design-driven markets. This computer software based platform provides a business framework for solving problems facing brands of how to approve for manufacturing or green-light, raise funds for manufacturing, measure demand, kill excess design concepts, eliminate unnecessary overproduction, prevent stock excess and stock shortages, and efficiently deliver to buyers new products in the high-pressure design-driven markets. This business framework allows for multiple business models to be built and supported through the computer software based platform.

Embodiments of the present disclosure can be used for any design-driven industry needing such efficient processes, including home décor, fashion, consumer electronics, etc. and other markets.

Embodiments of the present disclosure provide for a platform having modules for integration logic, process logic, decision logic, and big data analytics. Embodiments of the present disclosure enable transactions between demand-side and supply-side players. Prices of goods offered on the platform are set by the supply-side participants, and there is high sensitivity for a variety of products—the more variety offered on the platform, the better. The network effect is between buyers and sellers—sellers attract buyers, who attract more sellers.

Embodiments of the present disclosure provide for an integral logistical feature in that by aggregating various shipments, generally coming from the same manufacturing region within an allotted time period, can have the added advantage that the shipment is more cost-effective.

Embodiments of the present disclosure provide a computer software based platform using blockchain-based smart contract technology that connects brands with buyers and manufacturers in order to green-light or approve for manufacturing of new products. Embodiments of the platform addresses the brand's (i.e., the brand company's) need to initially gauge public interest, then efficiently fund, produce, and deliver goods or justify non-production by eliminating design concepts that don't meet set demand criteria, as well as the buyer's need to obtain new products at a lower price and lower shipment cost. Embodiments of the present disclosure provide a computer software based Marketplace software platform which provides a technological ecosystem for brand and buyers in design driven industries, effectively allowing brand companies to efficiently decide which new products to fund, produce, and deliver.

Embodiments of the present disclosure provide for a brand company to set up a new product page. The new product page can be set up and is not viewable to anyone except the brand company and the platform. The brand company can then push the soft button on the brand company's user interface associated with the computer software based platform to publish or “launch” the new product page. The new product page includes the various conditions of a pre-sale of the new product, with the understanding that any buyer who commits initially and then withdraws will pay a penalty, and that if a preset threshold amount of new product is not pre-sold or sold, then all offers and acceptances of the new product are null and void. If the threshold amount is pre-sold, then the platform completes the transactions and payments between all participating entities. When the new product page or webpage publishes to the platform, the new product page or webpage (referred to herein interchangeably as product page or product webpage) is visible to the brand that created and published the new product webpage, the computer software based platform administrator, and to all users having buyer user interfaces associated with the platform that were selected by the brand to access this new product page or webpage. In an embodiment, all entities registered with the platform can view the published new product page offerings.

In an embodiment, when a brand company creates a new product page, the brand company first creates it in draft mode so that the brand company can edit the information therein and create several such pages or web pages if they have a collection of various items and/or products. The new product page setup appears as a form template with multiple fields. The brand company can also indicate via the new product page setup which buyers—based on region or other criteria—will be able to see the new product page once published; thus, becoming a green-light Campaign™ event (i.e., system or method or process). In an embodiment, once the brand company is finished with entering all of the information on the new product page (or multiple pages for, e.g., a collection), the brand company can publish the draft new product page(s). The draft new product page(s) then becomes “a green-light Campaign™” event that buyers can see and participate in. In an embodiment, to view the page, users need a buyer interface and to be buyers that the brand company allows to view the published product page and participate in its green-light Campaign™ event for a specific product. The platform administrator and the brand company can see the product page, but other brand companies—even if registered with the platform or central controller—cannot see the product page. The brand company can decide to whom to give viewing rights and/or participation rights to the green-light Campaign™ event (i.e., system or method or process). Such viewing rights and/or participation rights can be stored in the platform database/server(s), and be stored as a part of a user profile, or can be provided by a link to the product page. In an embodiment, agent(s) and/or promoter(s) of the brand company can be given viewing rights and/or participation rights to the green-light Campaign™ event. In an embodiment, users can be granted viewing rights and not participation rights in the green-light Campaign™ event.

In an embodiment, a web interface running inside a user's browser program is used as a GUI. The web interface connects to the platform, including the backend server(s) and can access and transmit all data and commands to and from the server(s). In an embodiment, a mobile App is used as a GUI. In an embodiment, the mobile App connects to the platform, including the backend server(s) and can access and transmit all data and commands to and from the server(s).

In an embodiment, all entities registered with the platform can view the subsequent acceptances/pre-sale orders made by participants of the new product page. In an embodiment, when the new product page publishes to the platform, the brand company effectively deposits a token or currency amount which starts the blockchain. All buyers or other participants who then participate in submitting orders on the new product are included in the block records of the chain, with a surety amount or token or currency being deposited in anticipation of the preset time window closing of the new product offering. In an embodiment, the tokens or surety or currency taken from the brand company and other participants are put in a smart contract, so that when certain preset conditions are met in the smart contract, then the preset order and amounts of payments will occur automatically.

Embodiments of the present disclosure provide for a machine learning algorithm(s) which matches certain new product pages launched with certain buyers/agents/promoters. Embodiments of the present disclosure provide for a platform executing a machine learning algorithm which tracks a buyer's previous participation(s), records same in one or more databases, and then conducts a search and compare between the new product pages launched and key terms recorded such as the industry type, product type, price point, geography, et al. to determine potential recommendations for the buyer. Embodiments of the present disclosure provide for a survey for the buyer to complete when registering with the platform, the survey including detailed questions regarding the buyer's preferences which can be used by the machine learning algorithm as a starting base until more data is recorded when the buyer participates in subsequent new product offerings. The algorithm continues to track the buyer's participation and further narrows the new product page recommendations based on same. In an embodiment, the machine learning algorithm weights certain parameters more heavily than others, e.g., geographical location, in determining to which new product pages to alert a buyer.

Embodiments of the present disclosure utilize dAPPS (“distributed apps”) running on the Ethereum™ blockchain or other distributed ledger system that supports smart contracts or dAPPS, such as permissioned or permissionless distributed ledger technology to create secure contracts for each launched product, as well as to provide frictionless billing and payment service. In an embodiment, at the end of each successfully green-lit campaign for a new product, the contract payment in the form of tokens or desired currency is automatically transferred to the brand. No paperwork or billing is involved—everything being in electronic form. In an embodiment, users of the platform of the present disclosure—i.e., brands, buyers and manufacturers—are able to buy and sell tokens on the platform via an electronic wallet app (“application”). In an embodiment, the tokens can be used within the platform to fund the brands' new product campaigns. In an embodiment, no international billing and currency issues are present when tokens are the currency unit involved. In an embodiment, green-lit products generally have a staggered price scale which depends upon on a total volume of an order. In the present disclosure, aggregation of orders is possible in the electronic ecosystem created by the platform, and a combined order is expected to have a reduced price given the increased volume of the combined order versus a single buyer order.

Embodiments of the present disclosure incorporate geotargeting in the computer software based platform interface used by brands to select preferred buyers and delimit geographical areas for their new products. Embodiments of the present disclosure allow for third parties such as an agent or an influencer (i.e., not brand, supplier, manufacturer, buyer) are allowed to participate in the promotion of new products and share in the income from completed contracts.

Embodiments of the present disclosure provide for a tokenized system or value unit of currency which can be provided and/or generated via a variety of available sources.

Embodiments of the present disclosure provide for a system for a conducting a new product campaign on a networked system, including: at least one non-transitory memory; at least one hardware processor associated with a respective at least one non-transitory memory and configured to read instructions from the respective at least one non-transitory memory to cause the system to perform operations comprising: presenting, on a display of a user device, at least one of a first graphical user interface (GUI) and a first webpage; transmitting via at least one of the first GUI and a first webpage, a product webpage and a new product command to a computer software based platform, the product webpage including product data conditions, the new product command configured to initiate a distributed ledger with a first currency amount from a first electronic account; initiating the distributed ledger with the first currency amount by the computer software based platform; storing the webpage product data conditions by the computer software based platform in the respective at least one non-transitory memory associated with the at least one hardware processor; viewing via at least a second GUI the product webpage with the product data conditions stored by the computer software based platform; transmitting via the at least one second GUI an at least one acceptance command to the computer software based platform and at least a second currency amount from at least one second electronic account to the distributed ledger, wherein the product data conditions include at least a minimum threshold order volume and the at least one acceptance command includes at least one confirmed order volume; aggregating by the computer software based platform the at least one confirmed order volume into an aggregated order volume; comparing by the computer software based platform the aggregated order volume with the minimum threshold order volume, wherein when the confirmed order volume exceeds the minimum threshold order volume, then the distributed ledger is closed and at least one third currency amount is withdrawn from the respective at least one second electronic account by the computer software based platform and an order alert notification is transmitted to the first GUI by the computer software based platform.

Embodiments of the present disclosure provide for a system wherein the product data conditions include a temporal deadline during which the computer software based platform accepts the at least one acceptance command from the at least one second GUI, and the confirmed order volume exceeds the minimum threshold order volume within the temporal deadline. Embodiments of the present disclosure provide for a system wherein the product data conditions include at least one of: geographical location; minimum threshold order volume, maximum threshold order volume; shipping costs; manufacturing time; and shipping time.

Embodiments of the present disclosure provide for a system wherein the product data conditions include a temporal deadline during which the computer software based platform accepts the at least one acceptance command from the at least one second GUI, and the confirmed order volume does not exceed the minimum threshold order volume by the temporal deadline, then the computer software based platform transmits a command to end the distributed ledger and to transmit the first currency amount to a platform electronic account associated with the computer software based platform, and the at least one second currency amount to the at least one second electronic account.

Embodiments of the present disclosure provide for a system further including: comparing by the computer software based platform the aggregated order volume with the maximum threshold order volume, wherein when the confirmed order volume is equal to or greater than the maximum threshold order volume, then the distributed ledger is closed and at least one third currency amount is withdrawn from the respective at least one second electronic account by the computer software based platform and an order alert notification is transmitted to the first GUI by the computer software based platform. Embodiments of the present disclosure provide for a system further including transmitting a cancellation request of the at least one confirmed order volume via the at least one second GUI before the confirmed order volume exceeds the minimum threshold order volume and transmitting the at least a second currency amount to a computer software based platform account.

Embodiments of the present disclosure provide for system wherein the new product command includes a transmission command so that an alert is sent to at least one electronic address, the alert including a link to the webpage. Embodiments of the present disclosure provide for a system wherein the distributed ledger is a smart contract. Embodiments of the present disclosure provide for a system wherein the distributed ledger is viewable via the first and the at least one second GUIs.

Embodiments of the present disclosure provide for a system wherein the computer software based platform utilizes a machine learning module to identify and send a webpage alert to specific electronic addresses.

Embodiments of the present disclosure provide for a system wherein the at least one second GUI is associated with a respective at least one second electronic address and a respective at least one second user profile. Embodiments of the present disclosure provide for a system wherein the at least one second user profile includes at least one of geographical location, shipping constraints, timing constraints, industry of interest, products of interest, pricing constraints. Embodiments of the present disclosure provide for a system wherein the at least one second user profile is updated by the computer software based platform with at least one of the confirmed order volume and the product data conditions associated with any acceptance commands transmitted via the respective at least one second GUI, and wherein the computer software based platform utilizes a machine learning module to identify and send a webpage alert to specific electronic addresses based on a comparison of the respective at least one second user profile with the product data conditions. Embodiments of the present disclosure provide for a system wherein the geographical location is given priority by the machine learning module.

Embodiments of the present disclosure provide for a method for a green-light Campaign™ event of a new product, including: presenting, on a display of a user device, at least one of a first graphical user interface (GUI) and a first webpage; transmitting via at least one of the first GUI and a first webpage, a product webpage and a new product command to a computer software based platform, the product webpage including a new product description and product data conditions, the new product command being configured to initiate a distributed ledger with a first currency amount from a first electronic account; initiating the distributed ledger with the first currency amount by the computer software based platform; storing the product webpage with the product data conditions by the computer software based platform in the respective at least one non-transitory memory associated with the at least one hardware processor; viewing via at least a second GUI the product webpage with the product data conditions stored by the computer software based platform; transmitting via the at least one second GUI an at least one acceptance command to the computer software based platform and at least a second currency amount from at least one second electronic account to the distributed ledger, wherein the product data conditions include at least a minimum threshold order volume and the at least one acceptance command includes at least one confirmed order volume; aggregating by the computer software based platform the at least one confirmed order volume into an aggregated order volume; comparing by the computer software based platform the aggregated order volume with the minimum threshold order volume, wherein when the confirmed order volume exceeds the minimum threshold order volume, then the distributed ledger is closed and at least one third currency amount is withdrawn from the respective at least one second electronic account by the computer software based platform and an order alert notification is transmitted to the first GUI by the computer software based platform.

Embodiments of the present disclosure provide for a method wherein the product data conditions include a temporal deadline during which the computer software based platform accepts the at least one acceptance command from the at least one second GUI, and the confirmed order volume exceeds the minimum threshold order volume within the temporal deadline.

Embodiments of the present disclosure provide for a method wherein the product data conditions include a temporal deadline during which the computer based software platform accepts the at least one acceptance command from the at least one second GUI, and the confirmed order volume does not exceed the minimum threshold order volume by the temporal deadline, then the computer software based platform transmits a command to end the distributed ledger and to transmit the first currency amount to a platform electronic account associated with the computer software based platform, and the at least one second currency amount to the at least one second electronic account.

Embodiments of the present disclosure provide for a method further including: comparing by the computer software based platform the aggregated order volume with the maximum threshold order volume, wherein when the confirmed order volume is equal to or greater than the maximum threshold order volume, then the distributed ledger is closed and at least one third currency amount is withdrawn from the respective at least one second electronic account by the computer software based platform and an order alert notification is transmitted to the first GUI by the computer software based platform.

Embodiments of the present disclosure provide for a method further including transmitting a cancellation request of the at least one confirmed order volume via the at least one second GUI before the confirmed order volume exceeds the minimum threshold order volume and transmitting the at least a second currency amount to a computer software based platform account.

Embodiments of the present disclosure provide for a method, system, and computer software program product for conducting a new product campaign on a networked system, including: at least one non-transitory memory; at least one hardware processor associated with a respective at least one non-transitory memory and configured to read instructions from the respective at least one non-transitory memory to cause the system to perform operations comprising: presenting, on a display of a user device, at least one of a first graphical user interface (GUI) and a first webpage; transmitting via at least one of the first GUI and a first webpage, a product webpage and a new product command to a computer software based platform, the product webpage including product data conditions, the product data conditions including at least one of a minimum threshold product volume and a temporal deadline, the new product command configured to send access to the webpage to at least one electronic address; accessing by at least one second GUI the product webpage stored by the computer software based platform; transmitting to the computer software based platform an at least one acceptance command including a respective product volume amount; transmitting a respective first currency amount from an electronic account associated with the respective at least one acceptance command to a platform account; aggregating by the computer software based platform each of the respective product volume amount; comparing the aggregated product volume amount with the minimum threshold product volume, wherein if the aggregated product volume amount exceeds the minimum threshold product volume then the respective product volume amounts are transmitted to the first GUI for order processing and a second currency amount is withdrawn from the electronic account associated with the respective at least one acceptance command by the computer software based platform and stored in the platform account; and wherein if the aggregated product volume amount does not exceed the minimum threshold product volume then an alert is transmitted to the first GUI and a third currency amount is withdrawn from the platform account and transmitted to the electronic account associated with the respective at least one acceptance command by the computer software based platform.

Embodiments of the present disclosure provide for a minimum threshold order volume before a green-light Campaign™ event (i.e., system or method or process) succeeds with all order(s) accepted by the brand, and proceeds to manufacturing. Embodiments of the present disclosure provide for when the minimum threshold order volume is not met and/or exceeded, then the green-light Campaign™ event is cancelled and any Surety or initial currency deposit provided and/or charged is returned back to their sources. Embodiments of the present disclosure provide for when the minimum threshold order volume is met, exceeded and/or not met, a percentage of the Surety or initial currency deposited is deducted and given to at least one of the Brand, platform owner, or other entity.

Embodiments of the present disclosure provide for more than one level of threshold order volume. Each level of the threshold order volume can have a different price/item, different shipping price, different manufacturer sourcing, different geographical region, and/or different delivery time, or other logistics. In an embodiment, three levels of threshold order volume is provided to buyers who may participate in the new product or green-light Campaign™ event. For example, the three levels can be: (i) a minimum threshold order volume level such that if the aggregated confirmed order volume is less than the minimum, then the green-light Campaign™ event is canceled and any Surety or currency deposit charged is returned back to the respective entities; (ii) a medium threshold order volume level such that a better product price or offering or limited geographical region for delivery or shipping reduction or other beneficial offering is provided if the aggregated confirmed order volume meets or exceeds the medium threshold order volume level; and (iii) a maximum threshold volume level such that an even better product price or offering or limited geographical region for delivery or shipping reduction or other beneficial offering is provided if the aggregated confirmed order volume meets or exceeds the maximum threshold order volume level.

The various embodiments described and illustrated are for the purpose of showing some example embodiments of the present invention and are not intended to limit in any way the scope of the present invention.

Embodiments of the present invention provides a business-to-business (“B2B”), business-to-business-to-consumer (B2B2C), or direct-to-consumer (D2C) computer software based platform using blockchain-based smart contract technology to securely and publicly tracking the first release of one or more products or their designs, as well as any purchases, and/or their cancellations in the event of insufficient demand by a product designer (Brand company or Manufacturer).

Embodiments of the present invention provide for a set up to allow new users to the platform system to first access a Demo instance of the platform. That is, brands can initially create any Green-light Campaign™ event (i.e., system or method or process) pages on the Demo instance with the ability to subsequently transfer some or all of those created pages to the Live instance. The Demo instance has linked tutorials to bring users up to speed and allow demonstration and test of any features. The Demo instance includes a machine-learning functionality, and maintains and updates responses to the user based on the inputted information by the user as well as any significant pauses in activity, along with other trackable data.

Descriptions provided herein use a variety of terms, some of which will be used interchangeably—albeit distinct. For example, “brand company” or “brand” or “Brand” is used to describe a maker or design firm/company/individual/entity that creates and/or manufactures products. Brand manufactures products either by itself or through one or more contracts with manufacturing companies. For example, “buyer” or “Buyer” refers to an end consumer, professional buyer, or a retailer with a physically present store and/or an online or virtual retailer. In an embodiment, retailer holds and purchases its own stock or goods, which if the buyer is a retailer or professional buyer, the buyer can sell or offer for sale. In an embodiment, Buyer orders new product(s) by participating in green-light Campaign™ events (i.e., systems or methods or processes) set up by Brand.

And for example, “agent” or “Agent” is similar to a broker that comes with its own book of clients. Agent's clients can be Brands and/or Buyers. In an embodiment, an Agent receives a commission whenever a payment involving Agent's client occurs on the platform. In an embodiment, this commission is automatically sent by the platform or central controller when the payment involving Agent's client occurs to the Agent or Agent's designated proxy. In an embodiment, an Agent can be a “promoter” or “Promoter”, or an Influencer, who receives an introduction fee from Brand for promoting product(s). For example, a “distributor” or “Distributor” purchases a product in bulk or large quantities from Brand, and sells the product incrementally to Buyer. In an embodiment, the Distributor acts as an Agent, making money off of Distributor's clients (i.e., Brands and/or Buyers) on the platform. In an embodiment, Distributor acts as a Buyer, if the Distributor takes advantage of the platform via which to purchase product. In an embodiment, Distributor acts as a Buyer, if the Distributor takes advantage of the platform via which to purchase product in lesser than the usual minimum volume requirement, as allowed by the platform or green-light Campaign™ event. For example, “green-light Campaign™” or “Green-light Campaign™” or “new product campaign” is a mechanism for introducing new products and/or conducting business on the computer software based platform embodiments of the present invention. In an embodiment, the green-light Campaign™ event's (i.e., system's, method's, and/or processes') physical manifestation is a new product page set up which is launched by Brand, the new product page including all terms and details of the new product offering such as, inter alia, price per unit, minimum quantity, maximum quantity, shipping costs, timing. Once a new product page is launched on the platform, i.e., allowing others to view and act on the new product offering, a smart contract is created that records actions of participants and waits for the pre-set conditions of the offer to be met. In an embodiment, only buyers can participate in purchasing within green-light Campaign™ events. In an embodiment, agents, promoters, and/or buyers can participate in purchasing within green-light Campaign™ events. In an embodiment, only those entities who have an interface associated with the platform or central controller can participate in purchasing within green-light Campaign™ events. For example, “minimum order quantity” or “Minimum Order Quantity” or “MOQ” specifies the minimum total order volume that has to be met to “green-light” a new product campaign. In an embodiment, orders can be made by a single Buyer or multiple buyers or one or more entities. In an embodiment, Brand can arrange for multiple quantity levels, each quantity level having its own product price. In an embodiment, the larger the order volume, the cheaper the per unit price. In an embodiment, the MOQ is a required term of a green-light Campaign™ events. In an embodiment, MOQ is a first price level, Medium is a second price level, and Maximum is a third price level. For example, “minimum order increment” or “Minimum Order Increment” or “Order Increment” is the minimum volume required for an order that can be placed by Buyer and that corresponds to the minimum shipment that can be made for the respective new product. In an embodiment, the Minimum Order Increment is a term provided on the new product page. In an embodiment, the minimum size of the order matches with the new product's packing. For example, “surety” or “Surety” or “Assurance” refers to an instrument similar to a surety bond. In an embodiment, every green-light Campaign™ event participant, including Brand, pays Surety to indicate a level of seriousness of intentions or commitment. In an embodiment, backing out of a green-light Campaign™ event (i.e., system or method or process) or other similar failure to fulfill a promise/contract, can lead to forfeiture of the Surety. For example, “wallet” or “Wallet” or “Account” refers to simply an account of Brand, Buyer, Agent, Promoter, Distributor, and/or Manufacturer on the computer software based platform or central controller. In an embodiment, a wallet or account can contain crypto currency and/or tokens and/or regular currency. Embodiments of the present invention are not limited to only crypto tokens.

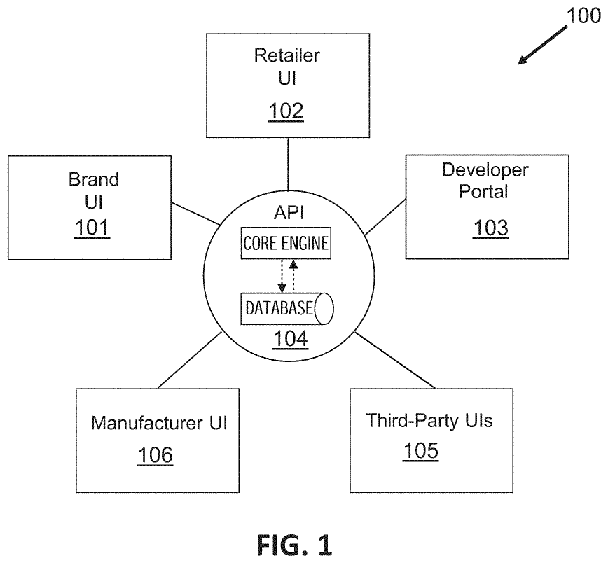

FIG. 1 shows an overall diagram 100 of an embodiment of the present invention. In FIG. 1, the system engine directly or via its API layer (application programming interface) 104 communicates with the brand company via a brand user UI (user interface) 101, with the retail company via a buyer UI 102, and with the developer portal 103 that should allow for easy integration with other systems or platforms. The system's engine 104 is essentially an “aggregation engine” that carries out the green-light Campaign™ event, simplifies logistics and product shipping. The engine 104 is computer software based, and also tracks using at least one database server, the various data entered in the system. In an embodiment, the engine performs data analysis on the tracked and/or stored data and generates business intelligence reports. A user —whether the brand 101 or buyer 102 or another—connects from its UI to the engine via the API, as according to available technological methods. This allows the user to access the platform's services and functionality via its respective UI.

Embodiments of the platform uses blockchain and smart contract technology in order to optimize all processes related to launching new products and shipment logistics—whenever aggregation is a factor. The platform seamlessly integrates geotargeting functionality used by brands when inviting buyers to participate in a green-light Campaign™ event for a new product. The platform optimizes placement of orders and subsequent aggregation and scheduling of shipping. With the help of Ethereum smart contracts or dAPPS based on other distributed ledger system that supports smart contracts, embodiments of the present invention provide a unique B2B platform that allows brands and buyers to pool resources, green-light or approve new products, as well as aggregate and optimize inventory and shipping logistics.

Embodiments of the present invention provide for an API that provides robust functionality for subscribing to push notifications for updates on the status of brands' Green-light Campaign™ events (i.e., systems or methods or processes) and shipping. In an embodiment, the API can be accessed via a web-based information portal or a third-party software. In an embodiment, the API is configured to publish Business Intelligence (BI) reports based on data stored in the database with product recommendations and inventory and shipment timing and aggregation suggestions based on the machine learning algorithms employed. Functionality and services of the API can be configured via the web-based developer portal. A user—whether buyer or brand company can log into the developer portal and select the services, et al. of interest for the user. API functionality is there for accessing data to feed other systems and platforms, such as an inventory system or a third-party Business Intelligence system.

Embodiments of the present invention provide for a computer software based platform working with its API to allow a brand company to extend its new product campaign by inviting third parties such as distributors, agents or promoters. This allows those third parties to facilitate a green-light Campaign™ event by accessing product data from the database and posting such product data on their systems and platforms. Upon approval by a brand who extended the invitation to a third party, the third party is allowed certain limited rights.

Those role-restrictive rights are predetermined via the developer's portal and/or the user's user interface. In an embodiment of the present invention, the platform extends the API services and pushes Business Intelligence and logistical data into third parties' internal systems and/or web sites.

From the tremendous growth in consumers' use of e-commerce to the rise of personalized mobile shopping apps and elaborate in-store shopping experiences, retailers are in a state of conventional disruption and vital transformation. Brands and retailers must address these changes head-on to meet consumer needs, stay relevant while remaining profitable. While online shopping is desirable for many shoppers, reportedly 70 to 80 percent of shopping still occurs at bricks and mortar stores, and, reportedly 75% of customers still want to see a product in store. See, Generational Perspective, Alliance Data, 2017. At the same time, physical retail—brick-and-mortar-stores are limited in their inventory and may not carry every size and color for each stocked product. Some innovative brick-and-mortar stores have transformed their stores into experiential showrooms bringing the latest fashion trends to their customers more quickly and in smaller quantities. This generates the same sense of urgency that is created by fast fashion and off-price buyers. Limiting quantities creates a scarcity of product and a sense of excitement and urgency in customer experience. This technique also keeps inventory fresher, as new inventory is cycling through more frequently. Retailers generally fit into three segments: brick-and-mortar (store having physical presence and location, but may also have an online presence), online (e-tailers that primarily sell goods via the Internet and do not have brick-and-mortar locations), and major Retailers (department stores present in multiple locations).

As brand companies (i.e., “brands”) juggle multiple products and/or transition from one season to the next, brands face several challenges. It will be understood that these challenges may be associated with a retailer or a professional buyer. 1) Product Inventory—The challenge for companies that supply products to retailers is that they must understand and anticipate the changing needs of the retailers and professional buyers and be able to provide the proper amount of merchandise, be nimble enough to supply reorders and not maintain excess inventory on hand at the end of the season.

2) Product Pricing and Customer Acquisition Cost (CAC)—The low wholesale price is paramount for the buyer even for a limited quantity of a product, in turn presenting a challenge to the brands, as they still need to place bulk orders with manufacturers. Consistently low product pricing allows brands to retain their customers. CAC for brands is extremely high—finding new customers requires regular participation in international trade shows and presence in other such venues, costing time, money, and personnel resources.

3) Product Quantity—Challenges 1) and 2) above can only be addressed effectively if the price of manufacturing the product is low enough to offer low wholesale prices to buyers. However, there are three issues with this: (i) lower prices for a product would require ordering in larger quantities; (ii) that would lead to excess inventory that would take longer to move; and (iii) excess slow moving inventory occupies precious space and generates waste by turning into dead stock. The buyer then does not place small orders due to the new product's high price and the effective lower return on investment, and misses out on potential customer business. An unfortunate side-effect of this is the brand would need to forego ordering smaller quantities of a product that otherwise could be a good revenue source and make available a potentially great product, and missing out on a new client relationship. These challenges are supply-side issues, as each can prevent brands from dealing in small product quantities or offering low wholesale prices to small and medium-sized buyers, putting these buyers at a disadvantage. There are demand-side problems as well.

Challenges faced by retailers and professional buyers include: 1) Space—the lifestyle showroom—upwards of 90% of consumer research starts online. While consumers still end up in a store for the majority of their purchases, the average number of store visits is under two per product search. Brick-and-mortar stores are paying the price of having to maintain a physical location while the online stores, apart from saving on rent and inventory maintenance, often get preferential tax treatment.

2) Product inventory and pricing—retailers and professional buyers have increasing pressure to continually offer new and unique products to customers at an agreeable price to entice fickle customers who oftentimes live in the near proximity and have a demand to see (and then buy) something new during every store visit. Therefore, new designs effectively motivate consumers for more frequent store visits often searching and comparing products online first. Furthermore, customers expect limited editions of unique and exciting items. Maintaining a constant flow of these items at agreeable prices in small enough quantities to be able to move them quickly can be challenging. There isn't a cost-effective way to order in small quantities at wholesale prices in the current system.

3) In addition, retail stores are no longer a place to stock inventory; they are lifestyle showcases for a brand that allow showrooms to indicate how customers' look and style will transform through their purchase.

There is a one-to-one correspondence between the Supply- and Demand-side problems in the domain of retailers and professional buyers. Accordingly, especially small to medium sized retailers and professional buyers would benefit the most by using the platform embodiments of the present invention, so the buyers can satisfy customers' demand for new and unique items by ordering products directly in smaller quantities while maintaining affordable lower prices in par with bigger in size (chain) stores' retail prices or increase its profitability.

Assuming the problems are addressed for the above ad hoc scenarios, there still remains a complex problem of payment friction. The issue of payment for international piecemeal orders (i.e., orders coming from multiple buyers in order to garner wholesale pricing) could be a significant impediment preventing the transaction from ever materializing. Due to the ad hoc nature of such transactions, the typical process of emailing an invoice, followed by check or electronic deposit for payment is impractical in this situation. The online invoice and payment may work, but the overhead time and effort by both parties to handle the payment can be impractical. If the parties are in different countries, it gets even more complicated as currency conversion and taxation issues come into play.

When identifying a counterparty to an international business transaction, the process of evaluating includes reviewing references and also their past dealings to determine payment terms. Especially for an ad hoc, small-size or piecemeal order, this would be impractical. In order to evaluate another party, one has to use online resources, business website, social media to make an educated guess about its reputation and trustworthiness. Both parties need mitigating the risk of dealing with unreliable parties.

In order for the brand to offer a product to the buyer—especially at a competitive RRP (Recommended Retail Price)—the brand has to be able to produce a large enough number of items. Imagine if there was a way for multiple buyers from different geographical areas to place a collective order to produce a new and exciting product in sufficient volume to warrant the lowest price—all the while the size of orders of individual buyers remaining small. With many parties to a single order of a considerable number of items to be manufactured and delivered, blockchain/distributed ledger technology offers an ideal solution.

Embodiments of the present invention provide a platform, i.e., a computer software based platform which pulls together orders from a multitude of localized buyers, helps maintain the high volume of production, and decreases production cost for brands and maintaining lower prices for buyers, despite the small order size of each individual buyer. Business-to-business new product campaigns among other technology tools and business intelligence capabilities of the computer software based platform embodiment can bring higher profits and reduce costs for brands and manufacturers, as well as for retailers, professional buyers and end consumers. In addition, the platform embodiment can provide logistical support and minimize shipping cost by offering options on aggregating product shipments and ordering additional items from the same manufacturing region—all combined with frictionless payments and with the convenience of a mobile application.

Embodiments of the computer software based platform includes an aggregating engine, a database, an API and a mobile application, plus additional application components to enable access via digital utility tokens or other unit. The platform embodiment is not only a technology but also provides an ecosystem that uses blockchain-based smart contracts to create innovative ways in which brands, manufacturers, buyers and related third-parties can participate in the launch of new products.

Embodiments of a computer software based platform can include:

1) Aggregation engine embodiment: This is the core of the platform which allows a user to green-light and launch newly designed products by amassing the required minimum quantity out of smaller orders from multiple buyers. Another function of the engine is to handle logistics by aggregating shipments.

Business Intelligence data can also be provided directly via the interface or via the API from the aggregation engine embodiment.

2) Web and mobile user interfaces embodiment: Web and mobile apps are the primary means for users to organize or participate in green-light Campaign™ events.

3) API-enabled services embodiment: Third-party systems can utilize the API for the API-enabled services of Business Intelligence, demand and environmental impact measurement, inventory management and logistics data feed, and money wiring and foreign exchange services including cryptocurrency exchanges.

4) Partners facilitation embodiment: Not including the brands, manufacturers and buyers that use the platform to green-light and produce new products, partners include any facilitating distributors, agents, influencers and promoters.

Embodiments of the platform, for the brand company or seller of new products, provide an efficient way to monetize designs and design ideas that otherwise would remain unfulfilled and makes it easier to get a newly designed product off the ground; still obtain generally bigger-sized orders which lead to lower product prices—wholesale and RRP; acts as a lead generation system for potentially larger project opportunities and lowers CAC; enables better use of time with more focus on design and less on marketing and customer acquisition thus maximizing income potential; and facilitates consolidation of shipments which generally leads to additional orders for products from the same manufacturing region and effectively higher revenues.

Embodiments of the platform, for the retail company or a professional buyer of new products, provide an effective generally higher demand from consumers and higher sales figures due to lower RRP (as discussed above), provides increased profitability due to elimination of the middle-man/distributor while being able to place smaller quantity orders and access better purchasing prices, as well as provides lower inventory and reduced risk of dead stock; releases purchasing budget funds since large inventory purchase is no longer required when a smaller order is desired; offers savings on consolidated shipments; and provides for higher inventory turnover due to smaller quantities of new products that can be ordered more frequently as desired.

Embodiments of the platform, for the brand and buyer, eliminates payment friction and hassle of accounts payable/receivable; facilitates cross-border transactions without currency concerns; and eliminates wasted time since neither would want to forfeit Surety funds escrowed in smart contract for bailing out of a green-light Campaign™ event.

Embodiments of the platform, for the consumer, effectively define production of new products, control environmental impact of consumer goods production by means of collective buying power, provide new products which are generally more affordable due to lower RRP, provides more consumer choice—diverse new products and collections can be offered every season; and facilitates more bargain-hunting and exclusive limited editions.

Embodiments of the platform, for the manufacturer, effectively provides increased revenues as more orders come from buyers (since such experience is more palatable for varying order sizes), increase in revenues due to economy of scale as average order size for a product increases; acts as a lead generation system for potentially larger project opportunities; and generally generates less waste due to economy of scale for larger-size orders which is more likely to turn into dead stock when ordered by a single buyer and not broken down among multiple buyers. In embodiments of the present invention, the risk of dead stock and wasted resources is minimized by eliminating excess of design concepts prior to production by means of collective buying power of multiple buyers.

Embodiments of the platform, for the agent and distributor or other third party, facilitates these third-party users to monetize existing leads of the brands and buyers; guarantees payment since it is embedded in the smart contract; and may provide a source of new business leads and/or projects.

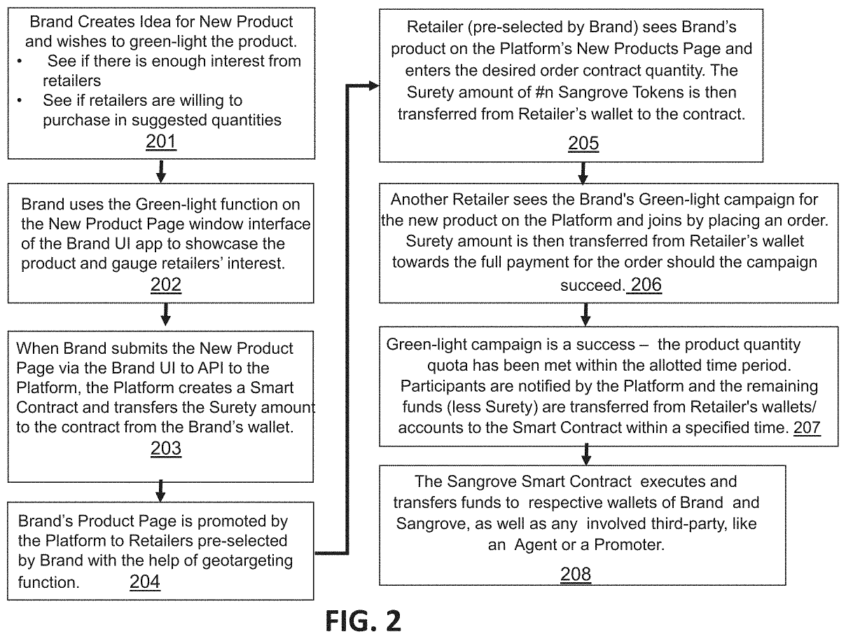

FIG. 2 shows a flowchart of a system platform embodiment of the present invention. In FIG. 2, the brand company (referred to herein as “brand”) creates an idea for a new product, and then decides to green-light the product 201. First, the brand company needs to see if there is enough interest from buyers, and second the brand company needs to determine whether buyers are willing to purchase the new product in the offered quantities that make budget-sense for the buyer. The brand company uses the green-light or publish function/button/command on the New Product Page window interface of the Brand UI app to showcase the product and gauge buyer's (referred to herein as “buyer,”) interest 202. When the brand company submits the new product page via its brand user interface or uploads via API from a third-party software or system to the API of the computer software based platform according to an embodiment of the present invention, the computer software based platform creates a smart contract and transfers the surety amount to the smart contract from the brand company's electronic wallet 203. The brand company's new product page is promoted by the platform to buyers preselected by the brand company 204. The brand company can use a geotargeting function available at the platform which, when selected, allows for the brand company to identify geographical areas of interest, and the platform will then allow the brand select targets to whom to promote the new product.

The buyer—from regions preselected by the brand company, receives the brand's product information on the platform's “new products page” and enters the desired order contract quantity 205. The surety amount of the required #n tokens is then transferred from the buyer's wallet towards the contract. In an embodiment, this is not a full payment. In an embodiment, another buyer sees the brand company's green-light Campaign™ event for the new product on the platform and also joins by placing an order. The surety amount of the required tokens is transferred from this buyer's electronic wallet towards the full payment for the order, should the campaign succeed 206. In an embodiment, the green-light Campaign™ event is a success which means that the product quantity quota has been met by one or more buyers or others who agreed via the smart contract to follow through with their order of a respective amount of the new product, within the preset allotted time period 207. Winning participants to this deal or contracts are notified by the platform and the remaining funds (the remaining funds is the originally agreed amount minus the surety amount) are transferred from buyers' wallets/electronic accounts to the smart contract, wired or debited in currency directly from buyers' financial account, within a specified time. The smart contract executes and transfers funds to respective wallets of brand company and the company sponsoring the platform, as well as any third party such as an agent or promoter, who receives payment for promotion services 208.

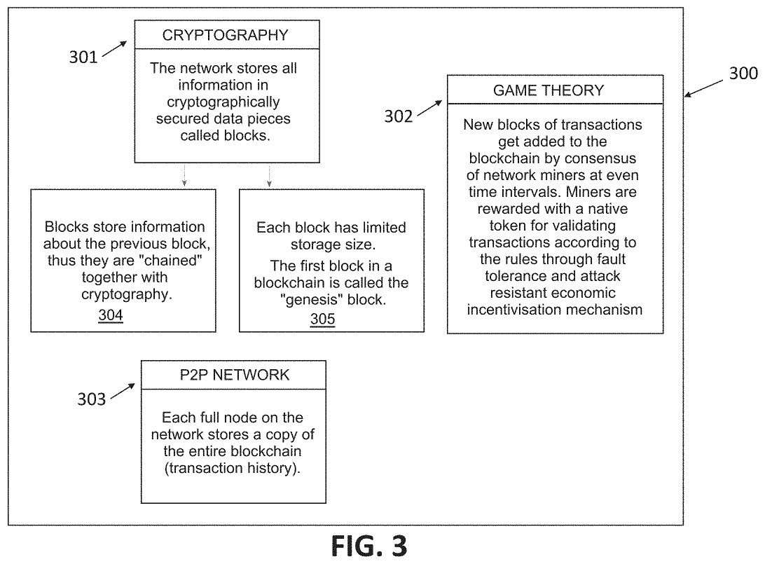

FIG. 3 shows a flowchart of blockchain technology 300 in an embodiment of the present invention. A blockchain is a continuously growing list of records, called blocks, which are linked and secured using cryptography 301. Each block typically contains a hash pointer as a link to a previous block, a timestamp and transaction data. By design, blockchains are inherently resistant to modification of the data. A blockchain can serve as an open, distributed ledger that can record transactions between two parties efficiently and in a verifiable and permanent way.

For use as a distributed ledger, a blockchain is typically managed by a peer-to-peer (P2P) network collectively adhering to a protocol for validating new blocks. Once recorded, the data in any given block cannot be altered retroactively without the alteration of all subsequent blocks, which needs a collusion of the network majority. For example, in FIG. 3, new blocks of transactions are added to the blockchain by consensus of network miners at even time intervals. Miners are then rewarded with a native token for validating transactions according to the rules through fault tolerant and attack resistant economic incentivization mechanisms 302. Each full node on the blockchain network stores a copy of the entire blockchain (i.e., transaction history) 303.

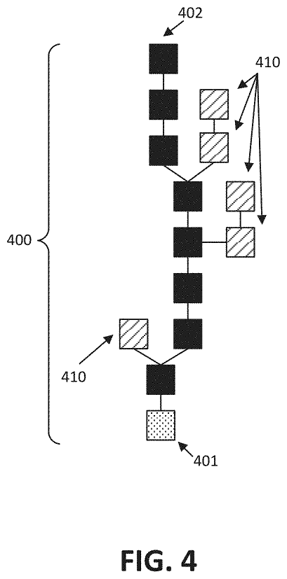

Blockchains are secure by design and are an example of a distributed computing system with high fault tolerance. This makes blockchains highly useful as the foundation of embodiments of the platform where security and transactional integrity are paramount. In FIG. 4, the first block in the blockchain is called the “genesis” block. Each block in a blockchain has limited storage size. Each block stores information about the previous block. The main chain 400 in the blockchain starts with the genesis block 401 and ends with the current block 402. The blocks which tangent off from the main chain are called orphan blocks 410. Those exist outside the main chain.

In an embodiment, Ethereum is used as a basis for part of the present invention, but other permissioned or permissionless distributed ledger system that supports smart contracts or dAPPS with their underlying native digital currencies can be utilized. The smart contracts of the Ethereum platform is a useful mechanism by which the interaction between the parties—including buyer and brand company—by which the interaction between the parties can be recorded as a transactional event with frictionless, cross-border payment. Ethereum is an available, open-source, public, blockchain-based distributed computing platform featuring smart contract (scripting) functionality. Ethereum provides a decentralized Turing-complete virtual machine, the Ethereum Virtual Machine (EVM), which can execute scripts using an international network of public nodes. Ethereum also provides a cryptocurrency token called “ether”, which can be transferred between accounts and used to compensate participant nodes for computations performed.

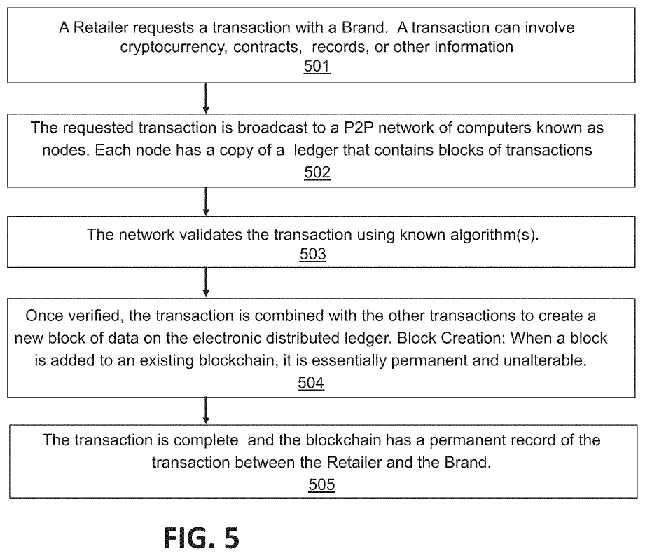

FIG. 5 shows an example blockchain workflow in an embodiment of the present invention. In 501, a buyer requests a transaction with a brand company. A transaction can involve cryptocurrency, contracts, records, or other information. In 502, the requested transaction is broadcast to a P2P network of computers known as nodes. Each node has a copy of a ledger that contains blocks of transactions. In 503, the network validates the transaction using known algorithms. In 504, once verified, the transaction is combined with the other transactions to create a new block of data in the electronic distributed ledger. When a block is added to an existing blockchain, it is essentially permanent and unalterable. In 505, the transaction is deemed complete and the blockchain has a permanent record of the entire transaction between the buyer and the brand company.

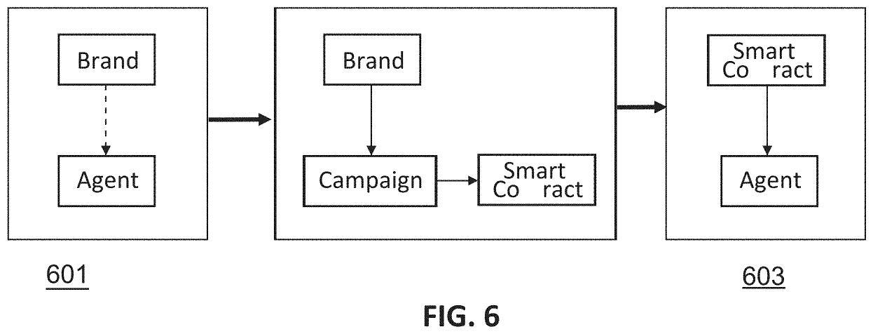

FIG. 6 shows an example smart contract workflow in an embodiment of the present invention. Smart contracts, in addition to that described herein, are computer software programs that run on the Ethereum blockchain and are triggered by transactions or other smart contracts. Embodiments of the platform of the present invention employ Smart Contracts. In embodiments of the present invention, the use of smart contracts eliminates the friction described herein associated with traditional order placement and payment systems, and ensure that all parties involved in a transaction are paid instantly, with irrefutable proof of the transaction.

In FIG. 6, the brand company agrees to pay an Agent for helping promote a successful green-light Campaign™ event in two weeks with the payment due at that time 601. The brand company creates a smart contract and transfers the required amount of Ether (surety amount) from the brand company's wallet/electronic account to the smart contract 602. The smart contract is set up to move tokens or currency to Agent's wallet in the preset time period, provided the necessary minimum to fund the product is raised by the end of the campaign promoted by Agent or facilitated by Agent's clients (buyers induced to participate on the platform). At the end of the preset time period, if the smart contract receives funds and meets the present minimum, i.e., successful campaign, then the tokens or currency is moved from the smart contract to the Agent's electronic wallet or account 603. Smart contracts, for example, are programs that run on the Ethereum blockchain and are triggered by transactions or other smart contracts. Similar smart contracts are available based on other blockchain or distributed ledgers. Embodiments of the present invention can involve one or more electronic accounts.

In an embodiment, e.g., see FIG. 6, for example, Brand agrees to pay an Agent for helping promote a successful green-light Campaign™ event within a preset amount of time, e.g., two weeks, with the payment due at that time 601. Brand creates a new products page or campaign page that creates a smart contract and transfers required #n Tokens (Surety) from Brand's wallet/electronic account to the smart contract. The smart contract is set up to move commissions to Agent's wallet/electronic account in two weeks (as preset), provided the necessary Minimum to fund the new product is raised by the end of the campaign and helped by Agent 602. At the end of the preset time or temporal deadline, e.g., two weeks, the smart contract receives funds from the successful campaign and commission is moved from the smart contract and transmitted to Agent's wallet/electronic account.

In an embodiment of the present invention, the systems and methods for securely and publicly tracking the origin and the ownership of the products or their designs is provided. Brands spend time and resources researching market trends, traveling to review products in other regions, and developing new product designs. Protecting a uniqueness of a design from copycats in the industry is difficult in design-driven industries where a novel design is paramount, but access to and input from buyers and agents is also necessary to determine if a viable market exists for the new product design. In embodiments, a green-light Campaign™ event is provided in which a smart contract or distributed ledger is utilized when a design of a product is a critical or important feature to the product. The use of the smart contract allows for a secure public record which is time stamped assisting in establishing a priority time and date for a specific product design and establishing an apparent ownership of the Brand posting the new product page on the platform. In an embodiment, when a Brand publishes a new product webpage to the computer software based platform, at the same time a command is sent along with a currency amount to initiate a smart contract or distributed ledger. The new product design offered is secured with the smart contract, including the terms of the product offering such as product information and product data conditions needed to fulfill the smart contract, as well as hashes of the product. As described in more detail herein, an executed smart contract provides a secure publicly viewable record having a time stamp and being ineligible for modifications. Accordingly, the aforementioned embodiment of the present invention provides for a secure method, system and process of protecting a product design priority date, while putting potential competitors and copycats on notice about the product design without impeding a Brand's business with buyers regarding the new product. Given that a block in the blockchain or smart contract cannot be subsequently modified, this provides critical proof of design which can be used as a priority document against others intending to seek intellectual property registration of the design they did not create or they attempted to register/protect at a later date. This also provides critical proof of design which can be used in litigation, given the established security of the smart contract.

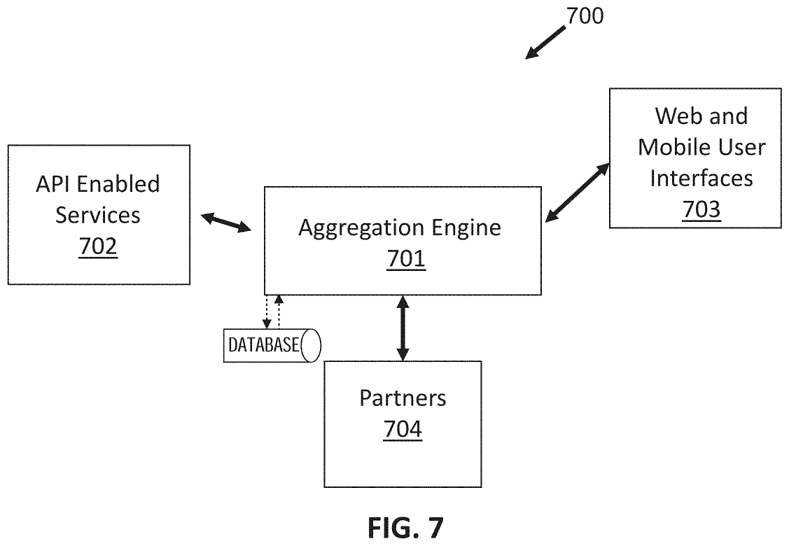

In FIG. 7, an example platform 700 according to an embodiment of the present invention is shown. The platform includes an aggregation engine 701. The aggregation engine connected to the database drives the entire system. The platform also includes API enabled services 702, web and mobile user interfaces 703, and partners 704. The platform is a high-performing system for connecting a variety of users, via a variety of communication protocols, and effects getting new products to market in a secure and technology efficient manner. In an embodiment, the computer software based platform includes multiple servers and/or databases which can be connected in a closed network, wired network, wireless network, via the Internet or in the cloud.

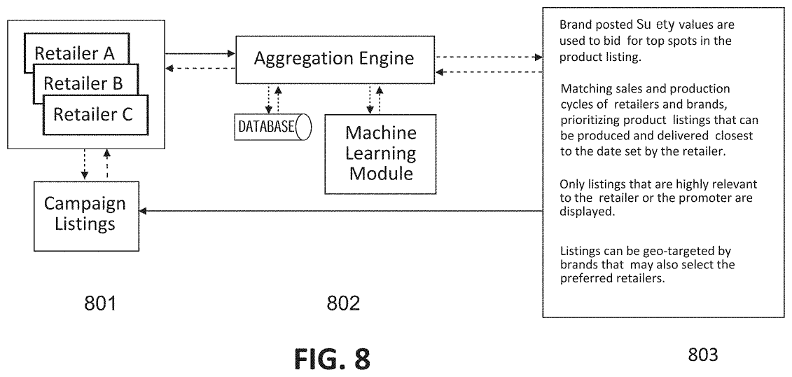

In FIG. 8, an example aggregation engine is shown. The aggregation engine is connected to the database and provides for a brand to conduct green-light Campaign™ events (i.e., systems or methods or processes) for new products by consolidating low volume orders from buyers selected based on a preset criteria; provides for a buyer, in addition to participation in green-light Campaign™ events, receive recommendations on combining and adding to shipments from the same manufacturing region and within a set time period 801. Via the aggregation engine, buyers can search green-light Campaign™ events, receive recommendations based on their history, and more. The aggregation engine takes multiple orders from multiple buyers within a preset time, geographical area, present listing of brand companies, and/or other preset options, in order to reach the minimum quantity threshold within the allotted time period set by the brand 802.

In an embodiment of the aggregation engine, the engine includes a machine learning module 803. The machine learning module updates user profiles with their transaction participation, past search criteria, and other data, and generates product recommendations based on the results. When providing recommendation, the platform uses past purchasing history, product ratings, user profile and past histories of users with similar profiles, brand ratings, product availability timing data, as well as products' geographic location once manufactured (for the purpose of shipping aggregation). As an example, the platform knows that a buyer is expecting a product in X number of weeks to be shipped from port Y while at the same time some other product Z should become available at that same time at that same location—all conforming with the buyer's prior buying or search history, the platform will then make an appropriate recommendation.

In an embodiment, the brand company posts via the platform Surety tokens or currency are firstly a security bond to guarantee the seriousness of brand's intentions to conduct the green-light Campaign™ event with intention to manufacture the product if the campaign is successful, but Surety can also be used to bid for top spots in the product listing. The aggregation engine also determines the matching sales and production cycles of buyers and brands, prioritizing product listings that can be produced and delivered closest to the date set by the buyer. For example, the aggregation engine can be configured to only display listings on the platform dashboard that are highly relevant to the buyer or the promoter or other involved party. For example, the aggregation engine can geotarget the listings by brands that may select the preferred buyers and is coincident in time and in the location of manufacturing or the port of loading of the shipment.

In an embodiment, e.g., as in FIG. 8, buyers search green-light Campaign™ events (i.e., systems or methods or processes) via their respective user interfaces on the computer software based platform. In an embodiment, buyers received recommendations for new product campaigns or green-light Campaign™ events that may be of interest to the buyer. A simple or complex algorithm is employed to determine the recommendations for a buyer, including, e.g., a tracking of previous new product campaigns that buyer has participated in, and matching one or more features of that green-light Campaign™ events/processes with one or more features of the pending green-light Campaign™ events/processes in order to determine the recommendations for the buyer 801. In an embodiment, the aggregation engine combines multiple orders from the multitude of buyers in order to reach the required minimum quantity threshold within the allotted time period set by the brand 802. In an embodiment, a machine learning module of the aggregation engine updates the user profiles and generates product recommendations based on those results, e.g., matching similar type of product or industry. In an embodiment, e.g., as in FIG. 8, Brand-posted Surety values can also be used by buyers to bid for top spots in the product listing 803. In an embodiment, the computer software based platform matches sales and production cycles of buyers and brands, prioritizing product listings that can be produced and delivered closest to the date set by the buyer. In an embodiment, only listings that are determined by the platform to be highly relevant to the buyer or the promoter are displayed. Such determination can be directly from the buyer in completing a survey, or in another manner. In an embodiment, listings can be geo-targeted by brands. In an embodiment, listings can be geo-targeted by brands. In an embodiment, brands select preferred buyers based on where the buyer is located geographically.

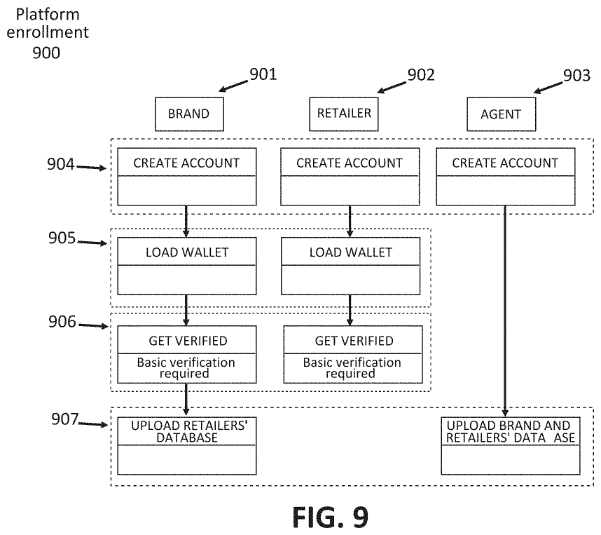

FIG. 9 shows a chart concerning enrollment 900 by a brand company 901, buyer 902 and agent 903 on an embodiment of the platform. The process begins with the brand company 901 launching a green-light Campaign™ event offering new product(s) to buyer(s) 902. Buyer(s) 902 participate in the green-light Campaign™ events organized by the brand company 901. An Agent 903 notifies preferred buyer(s) 902 of the brand company's 901 listings so that the buyer(s) 902 can view and participate in the green-light Campaign™ event. In this embodiment, the platform allows for a brand company to create an account 904, load an associated electronic wallet so that the brand company can launch green-light Campaign™ events, as well as engaging third party services such as the agent 903 promoting the brand company's new product. The brand company is also shown as needing to get verified 906 by the system, and uploading a buyer database so that the brand company can, e.g., search and service potential customers 907. The brand company 901 sets up a green-light Campaign™ event, the buyer 902 participates in the green-light Campaign™ event organized by the brand company, and the agent 903 notifies or promotes preferred buyers about a brand company's new product listings so that the buyers can become aware of them. Agent can create brands and buyers he represents and upload brand and buyer information on the platform.

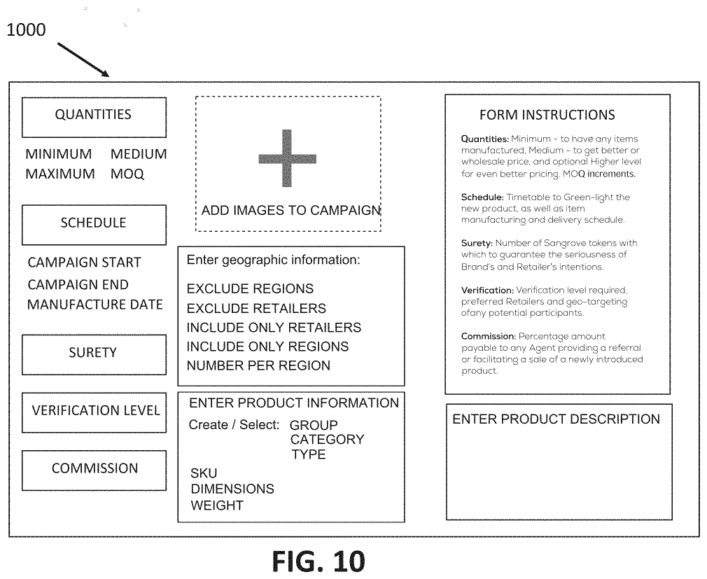

FIG. 10 shows an example graphical user interface 1000 in an embodiment of the present invention. For example, FIG. 10 shows an example new product page to be set up by the brand company. For example, the new product page can specify the minimum purchase amount, maximum amount, or other levels, or the number of items that need to be ordered and manufactured necessary to reach the displayed price level, a medium number of items in order to get a better price for the buyer, and an optional higher level for even better pricing per unit for a specific volume of product. For example, a brand can upload images to the new product page for the campaign. For example, the new product page can specify the timetable to green-light the new product, item manufacturing time, and/or delivery/shipping schedule. For example, the new product page can specify the surety. That is, what number of tokens with which a buyer, brand, or other entity needs to guarantee the seriousness of their intentions. This number can be arbitrary, or set automatically as a percentage of the total order. For example, the new product page can mandate verification of the entity intending to join the smart contract. For example, a verification level can be required if the entity is not of a preset, preferred buyers group, and the geotargeting of any entity may be effected to further assure the transaction is appropriate. For example, a commission amount payable to any Agent for providing a referral or facilitating a sale of a newly introduced product or even an old or stale product that was previously ordered to be manufactured but never paid in full.

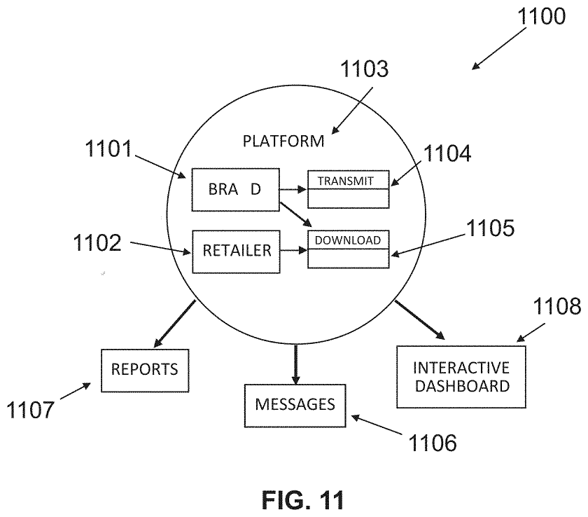

FIG. 11 shows an example system embodiment of the present invention. In FIG. 11, an example system of the present invention is shown in which users, such as buyer 1101 and brand 1102, communicate via a mobile 1103, handheld or portable processor, tablet, laptop, or desktop, or the like, with the platform. The system works over the Internet, closed-loop communication circuit, or other communication protocol 1104, to allow a user to view and enter into secure contracts via an interactive dashboard 1108, and download needed resources such as a buyers list by geography 1105. Via the platform, a user can generate messages to those who are a part of the chain as well as those who have not yet joined, and generate reports regarding various details tracked and/or recorded by the system 1106, 1107. In an embodiment, the green-light Campaign™ event status and other useful information is updated in near real-time by the platform.

In an embodiment, for example, the business intelligence reports is a data visualization allowing a combination of data and a choice regarding how to display it in order to identify trends. What was once cells upon cells of spreadsheet data has been transformed to engaging charts, graphs, gauges and tables. This makes data more actionable and with interactive dashboards, visuals are not stagnant, and thus potentially valuable to buyers and brand companies to have a feel for certain current trends. A user can click into the visual to drill down into different levels of information. This allows the user to follow a trend and dive deeper into what is driving that performance. In an embodiment, the platform provides a dashboard and watchlist windows and updates 1108, which can be sent to users via messaging 1107, and the data and statistics for any time period or geographical region or other search criteria can be accessed via reports 1106.

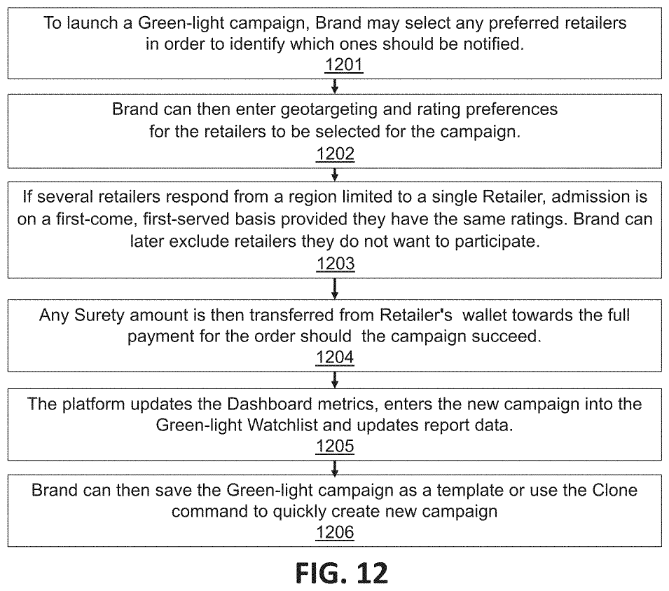

FIG. 12 shows a flowchart of a green-light Campaign™ event embodiment of the present invention. The green-light Campaign™ event involves several stages related to commitment and payment progression of the campaign participants. To launch a green-light Campaign™ event, a brand company may select any preferred buyers to be notified about the brand company's new product page or intended launch 1201. The brand company can then enter geotargeting, rating preferences and/or selection criteria, for the buyers to be selected for the campaign 1202. If several buyers respond from a region limited to a single buyer, admission is on a first-come, first served basis, provided the buyers have the same ratings 1203. The brand company can later exclude buyers that do not want to participate. Any surety amount is then transferred from the buyer's electronic wallet towards the full payment for the order should the campaign succeed 1204. The computer software based platform of the present invention then updates the dashboard metrics, enters the new campaign into the green-light watchlist, and updates report data 1205. The brand company can then save the green-light Campaign™ event as a template or use the clone command coded into the platform functionalities in order to expediently create a new product campaign.

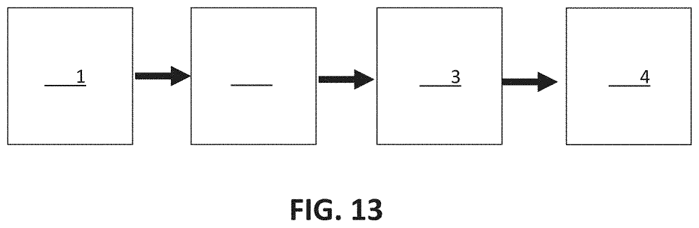

FIG. 13 shows a flowchart of a green-light Campaign™ event embodiment of the present invention. In an embodiment, a first stage 1301 is the Assurance token or initial currency deposit stage. This is the stage where a brand company can gauge interest in a new product. The brand company that launched the campaign, as well as the Buyers participating in the campaign, purchase, e.g., from tokens or currency that at this stage are immediately applied to the campaign as an assurance. This purchase is the participant's pledge of commitment to that specific new product green-light Campaign™ event. If a participant cancels out, then that participant will forego the token pledge already put forth, and that amount will be divided among the remaining participants and the platform or central controller accounts as compensation for the wasted time and effort.

In the new product page, when launching a green-light Campaign™ event, a brand company will have indicated a required amount of token pledge or assurance amount. This amount may vary based on the order size/volume. For example, a bulk-sized order will have a larger assurance amount required (i.e., required token pledge or nonrefundable deposit) compared to a lesser-sized order. Or, for example, an assurance amount requirement may be higher for some buyers based on past history or other known or unknown details. Or, for example, the platform or central controller can offer tokens for promotional purposes and cover the assurance amount for any campaign participant by providing the tokens as a credit.

In an embodiment, a green-light Campaign™ event progress is visually presented, e.g., on a GUI or dashboard, as a bar that represents the Green-light Minimum™ number of items that the brand company has to sell in order to launch production of the product. The bar is divided into intervals of minimum increments, which is a minimum number of items that can be ordered for the reason of product packing configuration—here represented as intervals. As Buyers place their orders and assurance pledges, the bar fills up incrementally with green (or other) color.

In an embodiment, the brand company can set up more than one price level. Once the Green-light Minimum™ number has been reached, additional orders may lower the price further given the reduction in price per item as quantity increases—as indicated in the settings and description of the green-light Campaign™ page.

If the Green-light Minimum™ number has been reached, participants are notified of the success of the 1st stage. The platform generates invoices for buyers as well as notifications that their bank accounts or wallets will be charged as per the 2nd stage, unless they immediately cancel their participation.

If the Green-light Minimum™ number has not been reached within the time specified, participants are notified of the campaign failure. That means, the green-light Campaign™ event failed to reach Green-light Minimum™ volume, or minimum order quantity (MOQ) for production, and so the Assurance tokens or initial currency deposit(s) remain in the system to be used in the next green-light Campaign™ event if they were provided by the platform as part of the promotion or if a participant indicates to the platform to keep the tokens to use in the next green-light Campaign™ event. Otherwise, for participants who purchased Assurance tokens, the platform will refund the respective bank accounts. In an embodiment, a percentage or flat fee may be deducted by the platform before refunding the remainder.

In an embodiment, a second stage is the deposit to launch production 1302. This second stage, if successful, will provide Brand with funds sufficient to launch product manufacturing (e.g., 30% of the total production figure). The platform or financial processor charges bank accounts or wallets of the participating Buyers on behalf of the brand company, as well as adds converted into currency Assurance and credits the brand company's account for the total of the deposit figure that the brand company set up on the green-light Campaign™ page minus the platform's and/or financial processor's commission and an Agent's commission, if any. Any financial processing fees are typically charged to Buyers separately. Funds initially accumulate on the financial processor account on behalf of the brand and are deposited to brand company's and/or the manufacturer's bank or wallet account once the 2nd stage is successful.

The brand company, Agent, and the platform accounts receive their respective percentage of the total (e.g. 80/15/5%) if the 2nd stage is successful. The respective percentages are set in advance of the new product launch. For example, the split is 80% for the brand company, 15% for the promotions Agent, and 5% for the platform account. Subsequently, if a brand company set up its manufacturer on the platform, the central controller or platform can transfer funds to Manufacturer's bank account on behalf of the brand company.

In an embodiment, if there is failure at the second stage 1302, that is, for example, if an unacceptable number of orders were canceled by buyer(s) and the necessary volume or Minimum Order Quantity was not reached as a result or order cancellations, or necessary funds could not be drawn from the buyer's bank accounts, the number being predetermined by the brand company or another, then the green-light Campaign™ event fails. The failed buyers' assurance and/or security is used to cover any financial fees and to reimburse the platform owner and remaining participants for their time and effort, with the rest refunded to participants, including platform owner and Agent fees. In an embodiment, the brand company may decide to cover or will cover any deficit towards the manufacturing and may end up with extra product.

In an embodiment, a third stage is the ready to ship stage 1303. At this stage, buyers provide payment for the remainder of the balance due (e.g. 70% of total) and the shipping fees. This stage is initiated strictly by the brand company within the time frame entered on the green-light Campaign™ page.

The platform tracks the calendar date and will send one or more reminders to the brand company that it is time to initiate this stage. The brand company cannot change this date after the launch of the campaign. In an embodiment, once the brand company initiates the third stage, the platform withdraws the remaining portion of the total from buyers' bank accounts. In an embodiment, similar to the second stage payment, the brand company, the manufacturer (if participating on the platform), Agent, and the platform accounts receive their respective percentage of the total. In an embodiment, any financial processing fees are charged to buyers separately. In an embodiment, once the third stage payments are received, the shipment is initiated.

In an embodiment, there can be a failure at the third stage. In an embodiment, if the brand company ends up with extra product, the brand company can sell it to buyers on the platform, either at the original green-light Campaign™ price or at a discount from the original price.

In an embodiment, the fourth stage is delivery 1304. The platform tracks the shipments and updates the respective buyer accounts.

In an embodiment, if at any time a participant claims error, or does not wish to satisfy obligations, the parties can have pre-agreed to a dispute resolution process.

In an embodiment of the present invention, various administrative efforts have been handled in an efficient manner by the platform. For example, a green-light Campaign™ event page acts as an Order Confirmation and a pro forma invoice for any buyer joining the campaign. A purchase order issued by the buyer to the brand company (seller) is created automatically when the buyer enters the green-light Campaign™ event as a participant. In an embodiment, when the green-light Campaign™ event successfully ends, the platform automatically issues an order confirmation and an invoice by the brand company to each participating buyer. All these interconnected documents will show the same green-light Campaign™ event reference number for ease of use and recording.

In an embodiment, a brand company or a third-party logistics provider can create custom shipping rates for different locations according to price and weight breaks and means of shipping. For each shipment, the brand company or a third-party logistics provider can specify shipping zones, price based rates, and weight based rates. For example, the brand company or a third-party logistics provider can create custom shopping zones for countries and regions that the brand company or a third-party logistics provider ships to on a regular basis, including any expected import fees or other fees needed for ensuring delivery. For example, the brand company or a third-party logistics provider can specify shipping rates based on the value of the customer's order. The brand company or a third-party logistics provider can create different rates according to the minimum and maximum order price, and even offer free shipping for orders above a certain volume as a promotional offer. The brand company or a third-party logistics provider can specify shipping rates in sales orders based on the total weight of the items in customer's order. The brand company or a third-party logistics provider can create different rates based on minimum and maximum order weights.

In an embodiment, though the computer software based platform uses tokens internally, the brand company and buyer can perform transactions and generate reports in their preferred currencies, such as Euro, Dollar, Pound. Due to the nature of the business, immediate payments have to be made to order merchandise and/or to pay suppliers or manufacturers.

In an embodiment, token usage would usually be linked to some commercial benefit such as discounts or rebates to promote their use. In an embodiment, other crypto or fiat currencies can be used. For brand companies, the platform may offer signup bonus tokens and various rebates for using certain third-party services. The brand company may receive reduced fees for advertisement and other services through the platform. For buyers, they can participate in green-light Campaign™ events for new products without friction and with the convenience of using a mobile application. Buyers may receive signup bonus tokens and various rebates for using third-party services. For agents, distributors, and promoters, they can earn tokens for the platform by promoting green-light Campaign™ events and new products. They may be offered the opportunity to be buyer of new products launched via the platform. Partners are companies and entities that provide specialized services to participants and will have the opportunity to earn tokens through providing, for example, such services.

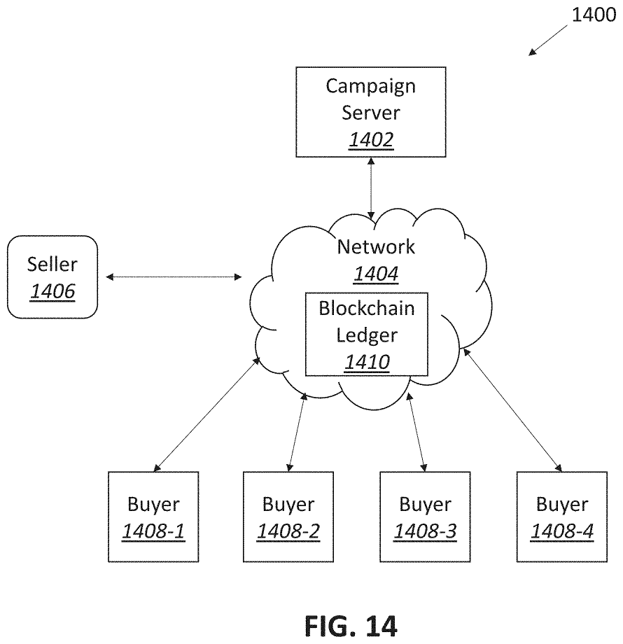

FIG. 14 is a representation of a product tracking system 1400, according to at least one embodiment of the present disclosure. The product tracking system 1400 includes a campaign server 1402. The campaign server 1402 may be connected to or be a part of a cloud network 1404. A seller 1406 may utilize the campaign server 1402 to sell a product. For example, the seller 1406 may transmit to the campaign server 1402, over the network 1404, information regarding the product. Such information may include the product description, images of the product, pricing information, shipping information, and so forth.

In accordance with embodiments of the present disclosure, the campaign server 1402 may request information regarding a particular product. For example, the requested product information may include details regarding the product, such as a buyer's price, suggested retail prices, product characteristics, manufacturing/origin region, product image and/or other information requested by the campaign server 1402 or is otherwise provided by the seller 1406. The campaign server 1402 may provide the seller 1406 with a template into which the seller 1406 enters their product information, such as a spreadsheet or other template. The seller 1406 can complete the template and upload the contents through a seller 1406 user interface (“UI”), where the information is parsed to create a listing for each of the products. In another example, the seller 1406 may provide product information to the campaign server 1402 in their own format and a campaign manager at the campaign server 1402 may transfer the product information to the necessary form or template for bulk upload into the campaign server 1402. In some examples, the campaign server 1402 may include logic, an algorithm, or machine learning tools that process or analyze seller 1406-provided product information and parse, extract and organize into individual product listings. In some embodiments, the seller 1406 UI may include an interface through which the seller 1406 can enter product information individually to create each product listing.

A product offered by the seller 1406 may have various information associated therewith that informs a prospective buyer (collectively 1408) about relevant details of the product. For example, the product information can include a price to the buyer 1408 for each unit of product, the quantity of product in each orderable unit, a suggested retail price of the product, the time it will take to manufacture the product, the location or port at which the product will be made available to the buyer 1408, a minimum orderable amount of the product, a MOQ for manufacture of the product and/or other product information. The minimum orderable amount of the product is the minimum number of units of a product that a buyer 1408 is required to purchase, which may be based on shipping units, manufacturing processes, and so forth. The MOQ is a value set by the seller 1406 and is a minimum total number of units that are required to be sold during the campaign for the product to be “greenlit” and be produced. This minimum threshold order volume may help to prevent the manufacture of less desired products by ensuring there is a minimum amount of demand for a product before it enters production. This reduces product waste early on in the process of a products life cycle.

In some embodiments, the seller 1406 may also provide product information that tiers sales of the product. For example, the seller 1406 may provide multiple prices as part of the product information, with each price corresponding to a different threshold of order volumes. That is, a first price of the product may be associated with a first threshold of order volumes and a second price, lower than the first, may be associated with a second threshold of order volumes greater than the first. In this manner, as more and more of the product is ordered by buyers 1408, the price per unit of product to the buyer 1408 may decrease, such as due to the economies of manufacturing additional volume of the product. With the use of such tiered pricing, all buyers 1408 who purchase units of a product whose price drops due to the volume ordered will be charged the final, reduced price regardless of when they purchased the product during the campaign. This allows all the participating buyers 1408 to benefit from the reduced pricing of the product. The seller 1406 may selectively choose to disclose tiered pricing of a product to the buyers 1408 during a campaign, either allowing buyers 1408 to view the tiered pricing at any point during or at specified a point(s) during the campaign, or simply displaying a changed price for the product. Similarly, the seller 1406 may specify that products whose price changes during the campaign are highlighted when such occurrences occur, such as by providing a graphical or textual notification of the price change, by reordering the products in the campaign and/or by other means of notifying some or all of the participating buyers 1408 of the price change.

In some embodiments, the campaign may be associated with a sales event, which may include multiple products sold by the seller 1406. The seller 1406 may set different prices, threshold, shipping terms, and other incentives to encourage the purchase of multiple different products from the same sales event. For example, a first price of a first product may be reduced if a buyer buys a quantity of a second product. This may help the seller 1406 to achieve the MOQs of more products.

In some embodiments, the seller 1406 may employ dynamic pricing for their products. The dynamic pricing can be predetermined prices that correspond to various triggers, such as time, amount of product sold, time between product purchases and/or other factors. Alternatively, the dynamic pricing may be a range of pricing for each product and the seller 1406 or the platform may provide an algorithm that dynamically adjusts the product pricing within the predetermined price range based on a variety of factors. In an embodiment, such an algorithm can be machine learned and trained on previous campaign data to dynamically price the products of a current campaign. In the use of an algorithm, the seller 1406 may be presented a selection to specify the goal of the dynamic pricing, such as to achieve the minimum threshold order volume in the quickest manner, maximize the revenue of the sale for the seller 1406, to encourage sustained purchasing, to intervene when product sales are stagnant, and/or other factors that can be specified for the seller 1406 to employ the dynamic pricing algorithm. Additionally, the seller 1406 can alter the selection of the goal of the dynamic pricing algorithm during the campaign, such as by selecting a goal and activating the dynamic pricing or changing from one goal to another goal.

In some embodiments, the tiered product information may be applied to other aspects of the product. For example, the delivery date of the product may be tiered and dependent on the total number of units of a product that have been ordered. For example, an initial tier may be that a certain amount of ordered product will be scheduled for delivery by a first date and additional units of product ordered beyond that certain amount will be scheduled for delivery by a second, later date. This can allow the seller 1406 to sell a larger number of units of a product without straining the manufacturing capacity that has been contracted to manufacture the product and allow buyers 1408 to order more units of product than would have been otherwise available if all the product ordered had the same delivery date.

In some embodiments, the seller 1406 may include a maximum number of orderable units of product. The maximum can be applied to each buyer 1408 and/or may be a global maximum. For example, the seller 1406 may specify that each buyer 1408 may only order a maximum number of units of a product, that there are a maximum number of units of a product available during the campaign, or a combination thereof. This allows the seller 1406 to assist more buyers 1408 in being able to order units of the product and/or prevents the seller 1406 from creating production issues with regards to a product.

During the campaign, the seller 1406 may modify product information and/or thresholds through the seller 1406 UI. Preferably, the alteration of the product information is a minor correction or an expansion or addition of thresholds beyond what were previously defined. In this manner, the changes are not limited to the product availability during the campaign. However, it is understood that instances and events may need to be accounted or compensated for by altering product information/thresholds during a campaign.

When the seller 1406 initiates the product campaign, the campaign server 1402 may create a blockchain ledger 1410. The blockchain ledger 1410 may be associated with the product campaign. For example, the blockchain ledger 1410 may include a record of each portion of the product information provided by the seller 1406 to the campaign server 1402. In some embodiments, the first block of the blockchain ledger 1410 may include the initial product information provided to the campaign server. Any changes to the product information may be recorded with a new block in the blockchain ledger 1410. In some embodiments, the blockchain ledger 1410 may include the terms and conditions for the sale of the product. For example, the blockchain ledger may include pricing terms, shipping terms, the MOQ, and so forth. As discussed herein, including the terms and conditions in the blockchain ledger 1410 may create a public record that is difficult or impossible to modify. This may make enforcement by both the seller 1406 and the buyer 1408 easier.

As may be seen, the campaign server 1402 facilitates sale of the seller 1406's product with multiple buyers 1408. Conventionally, a seller 1406 and a single buyer 1408 may enter into a contract for a product. But if the buyer 1408 cannot purchase the MOQ of the product, then the seller 1406 and the buyer 1408 may not enter into a contract, resulting in lost sales for the seller 1406 and the lost opportunity to use or re-sell the product for the buyer 1408. This may result in sellers 1406 only selling their product to very large buyers 1408 who can buy the MOQ of the product by themselves. In accordance with embodiments of the present disclosure, the campaign server 1402 may facilitate the sale between a single seller 1406 and multiple buyers 1408 (e.g., between the seller 1406 and one or more of a first buyer 1408-1, a second buyer 1408-2, a third buyer 1408-3, a fourth buyer 1408-4, or more buyers). This may allow smaller buyers 1408 the opportunity to purchase smaller volumes of the seller's 1406 product by combining their purchasing power, thereby increasing the efficiency of a product campaign.

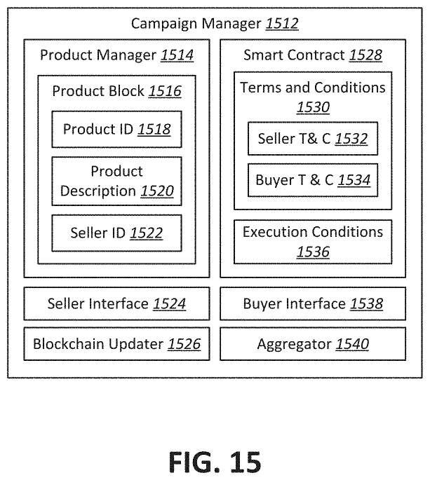

FIG. 15 is a representation of a campaign manager 1512, according to at least one embodiment of the present disclosure. In some embodiments, the campaign manager 1512 may be implemented by the campaign server 1402 of FIG. 14. Put another way, the campaign server 1402 of FIG. 14 may implement the campaign manager 1512.

The campaign manager 1512 may receive product information from a seller and host a marketplace for the seller's product. The campaign manager 1512 may provide a portal or other interface for buyers to review the seller's product and submit purchase orders. The campaign manager 1512 may further create a smart contract on the blockchain ledger, including the product information, terms and conditions, MOQs, and so forth.

The campaign manager 1512 may include a product manager 1514, which may receive the product information from the seller and generate a product block 1516. The product block 1516 may include information about the product, as provided by the seller. For example, the product block may include a product ID 1518, a product description 1520, and a seller ID 1522. The seller may input the product information to the campaign manager 1512 using a seller interface 1524. The seller interface 1524 may include a UI that may allow the seller to input the product information to the campaign manager 1512.

The product block 1516 may be recorded in the blockchain ledger by a blockchain updater 1526. In some embodiments, the product block 1516 may be recorded as the first block in the blockchain ledger for the product campaign. This may help to create a verifiable record of the product information to which the seller and the buyer may refer throughout the product campaign. In some embodiments, the product description 1520 may provide intellectual property production for the design and/or features of the product. For example, the product description 1520 may include an image of the product (or a hash of an image, as discussed herein), including product design and/or features. Because the product description 1520 is recorded in the blockchain ledger, the product design and/or features may be recorded in the blockchain ledger as well. This may help to protect the seller from a subsequent seller beginning a campaign using the same product.

The campaign manager 1512 may further generate a smart contract 1528. The smart contract 1528 may be a record of the agreements, terms, and conditions of the product campaign. For example, the smart contract 1528 may include a set of terms and conditions 1530. The terms and conditions 1530 may include seller terms and conditions 1532 and/or buyer terms and conditions 1534. The seller terms and conditions 1532 may include the obligations that the seller is under if the smart contract 1528 is executed, as discussed in further detail herein. For example, the seller terms and conditions 1532 may include manufacturing duration, manufacturing location, shipping policies, quality standards, delivery date, quantities, any other seller terms and conditions, and combinations thereof. The buyer terms and conditions 1534 may include price agreement, payment plans, payment methods, quantities, shipping policies, receiving conditions, any other buyer terms and conditions, and combinations thereof.

The details of the smart contract 1528 may be recorded on the blockchain ledger by the blockchain updater 1526. In some embodiments, the details of the smart contract 1528 may be recorded on the blockchain ledger after every action in the product campaign. For example, the smart contract 1528 may be updated after every adjustment to the terms and conditions 1530. In some examples, the smart contract 1528 may be updated on the blockchain ledger after every purchase order by the buyer. In this manner, a publicly verifiable record of the product campaign may be available in the blockchain ledger. This may help to improve the efficiency and ease of contract enforcement.

The smart contract 1528 may further include execution conditions 1536. The execution conditions 1536 may be the conditions under which the smart contract 1528 is executed. For example, the execution conditions 1536 may include the MOQ of the product. If the buyers in aggregate order the MOQ, then the smart contract 1528 may be executed. Executing the smart contract 1528 may result in the seller being contractually obligated to perform the seller terms and conditions 1532 (including manufacturing and/or shipping the product) and the buyer being contractually obligated to perform the buyer terms and conditions 1534 (including paying for and receiving the product). In this manner, if the smart contract 1528 is executed, the seller may be obligated to manufacture and/or distribute the product, and the buyer may be obligated to purchase and/or receive the product. While embodiments of the present disclosure discuss execution conditions 1536 with respect to the MOQ, it should be understood that other execution conditions 1536 may be applied to the smart contract 1528, such as availability of resources to produce the product (e.g., supply chain availability), availability of funding (e.g., loans, investors, or other funding) for the seller and/or buyer, passing of a period of time, total financial value of sales amounts, any other execution conditions 1536, and combinations thereof.

In some embodiments, the buyers may participate in the product campaign through a buyer interface 1538. The buyer interface 1538 may include a portal, a UI, or other mechanism by which the buyer may review details of the product block 1516. In some embodiments, the buyer may submit a purchase order to the campaign manager 1512 through the buyer interface 1538. The purchase order may include buyer information, including a buyer ID, a purchase quantity, and any special pricing agreements or other special agreements entered into with the seller. When the buyer submits the purchase order, the blockchain updater 1526 may update the blockchain ledger with the purchase order and/or details from the purchase order. In some embodiments, this may result in an update to the smart contract 1528, including an update to the list of buyers. As discussed herein, by updating the blockchain ledger with details from the purchase order, a permanent and public record of the transaction is created, thereby making the contract easier and more efficient to enforce.

The campaign manager 1512 may include an aggregator 1540 which may review each block from the blockchain ledger and aggregate the purchase orders and other commitments. In some embodiments, the aggregator 1540 may combine the total number of units sold. In some embodiments, the aggregator 1540 may combine the financial value of all of the purchase orders. In some embodiments, the aggregator 1540 may combine the total number of buyers. In some embodiments, the aggregator 1540 may combine any other metric regarding the purchase orders of the product during the product campaign. In some embodiments, the aggregator 1540 may maintain a separate tally or accounting of the product campaign. In some embodiments, the aggregator 1540 may send the aggregated totals of the product campaign to the blockchain updater 1526 to be recorded in the blockchain ledger. In some embodiments, the totals may be uploaded to the blockchain ledger at the end of the product campaign. In some embodiments, the totals may be uploaded to the blockchain ledger after each purchase order. In some embodiments, the aggregator 1540 may aggregate the purchase orders after each purchase order. In some embodiments, the aggregator 1540 may aggregate the purchase orders periodically, such as after a period of time. In some embodiments, the aggregator 1540 may wait to aggregate the purchase orders until after the product campaign has ended.

In some embodiments, the totals from the aggregator 1540 may be used to determine whether one or more of the execution conditions 1536 have been met. For example, if the execution condition 1536 is an MOQ, the total quantity of units aggregated using the aggregator 1540 may be compared to the MOQ. If the total quantity of units is equal to or greater than the MOQ, then the execution conditions 1536 may be satisfied.

In some embodiments, the aggregator 1540 may ingest and aggregate the information of each sales event and can aggregate the information from multiple sales events and/or product campaigns. During a sales event or product campaign, the aggregator 1540 tracks the sale of individual products to determine if and/or when a product achieves the minimum threshold order volume. When the threshold is achieved, the aggregator 1540 can initiate the execution of the smart contracts and the recording of the smart contracts in the blockchain ledger for each product. In this manner, the purchases of a product by multiple buyers may be aggregated by the aggregator 1540.

In an embodiment, the aggregator 1540 may also aggregate other information, such as various product information. For example, the aggregator 1540 may track the purchases of each buyer and the location from which the purchased products are to be shipped from after production The aggregator 1540 may aggregate purchases from a port of origin to make shipping more efficient, by combining orders from multiple buyers into a single shipment that can then be shipped closer to a group of buyers and then disbursed, which may reduce shipping costs for each buyer. Alternatively, the aggregation of shipping may be applied to an individual buyer, aggregating purchases from multiple sales events. For products having a shared port of origin, the aggregator 1540 can aggregate these purchases into a single shipment. For example, the aggregator 1540 may delay shipping of a purchased product from the point of origin so that it may be combined with later manufactured products so that the product shipments can be aggregated, which can increase the shipping efficiency, reduce expenses and/or reduce environmental impacts.

In some embodiments, the campaign manager 1512 may provide the aggregator 1540 with information regarding various shipment methods and can recommend purchases, or provide notices to a buyer regarding purchases, to increase the efficiency and/or reduce cost of shipping products from a point of origin. For example, the aggregator 1540 may use the known dimensions of the products and the known dimensions of a shipping container to determine remaining available shipping space for a buyer from a port of origin. The aggregator 1540 can then notify the buyer when a purchase would exceed the remaining shipping capacity so that the buyer may reassess whether to purchase the item as the shipping efficiency may be reduced and/or costs increased due to the need to acquire additional shipping capacity for the purchase. Similarly, the aggregator 1540 may cause the products of a sales event to be reordered and/or filterable to highlight products that would not exceed the remaining shipping capacity, thereby increasing the shipping efficiency. Further, the aggregator 1540 may also account for the temporal aspect of the purchases, such as when the products are expected to be delivered/completed by the seller and/or manufacturer. In this manner, the shipping efficiency of the purchased products can be improved without unduly delaying the shipping. Further, the aggregator 1540 can perform such shipping aggregation for each buyer individually and/or for a group of similarly located buyers. The aggregation of shipping further reduces the waste and environmental impact of a product.

In accordance with embodiments of the present disclosure, when the execution conditions 1536 are satisfied, the campaign manager 1512 may instruct the seller to perform the seller terms and conditions 1532 (e.g., the manufacture and/or distribute the product) and the buyer to perform the buyer terms and conditions 1534 (e.g., to pay for and receive the product). In some embodiments, the campaign manager 1512 may instruct the seller to perform the seller terms and conditions 1532 using the seller interface 1524 and the buyer to perform the buyer terms and conditions 1534 using the buyer interface 1538. In some embodiments, the campaign manager 1512 may instruct the seller and/or the buyer to perform their respective terms and conditions in any other manner, such as through an email, an instant message, a phone call from a human operator, any other manner, and combinations.

Each of the components 1514-1540 of the campaign manager 1512 can include software, hardware, or both. For example, the components 1514-1540 can include one or more instructions stored on a computer-readable storage medium and executable by processors of one or more computing devices, such as a client device or server device. When executed by the one or more processors, the computer-executable instructions of the campaign manager 1512 can cause the computing device(s) to perform the methods described herein. Alternatively, the components 1514-1540 can include hardware, such as a special-purpose processing device to perform a certain function or group of functions. Alternatively, the components 1514-1540 of the campaign manager 1512 can include a combination of computer-executable instructions and hardware.

Furthermore, the components 1514-1540 of the campaign manager 1512 may, for example, be implemented as one or more operating systems, as one or more stand-alone applications, as one or more modules of an application, as one or more plug-ins, as one or more library functions or functions that may be called by other applications, and/or as a cloud-computing model. Thus, the components 1514-1540 may be implemented as a stand-alone application, such as a desktop or mobile application. Furthermore, the components 1514-1540 may be implemented as one or more web-based applications hosted on a remote server. The components 1514-1540 may also be implemented in a suite of mobile device applications or “apps.”

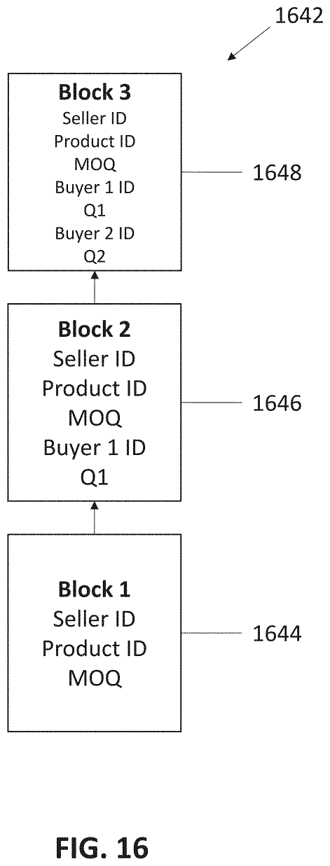

FIG. 16 is a representation of a blockchain ledger 1642 of a product campaign, according to at least one embodiment of the present disclosure. The blockchain ledger 1642 shown includes three blocks. The first block 1644 may include the initial product information provided by the seller. For example, the first block 1644 shown includes a buyer ID, a product ID, and a MOQ for the product. However, it should be understood that the first block 1644 may include any other information, as discussed herein.

In some embodiments, after a first buyer has made a purchase order, the blockchain ledger 1642 may be updated with the purchase order information. Updating the blockchain ledger 1642 may include preparing a new block, or the second block 1646 in the embodiment shown. The second block 1646 may include the information from the first block 1644, as well as the additional information associated with the purchase order, including a first buyer ID and a first order quantity (e.g., “Q1”). In some embodiments, the second block 1646 may include an exact representation of the information from the first block 1644. In some embodiments, the second block 1646 may include a hash of the information from the first block 1644. Using a hash may allow for a quick comparison between the hash and the original material to determine any changes while reducing the size of the second block 1646. This may help to increase the security and accuracy of the blockchain ledger 1642.

In some embodiments, after a second buyer has made a purchase order, the blockchain ledger 1642 may be updated with the updated purchase order information. As discussed herein, updating the blockchain ledger 1642 may include preparing a new block, or the third block 1648 in the embodiment shown. The third block 1648 may include all the information from the second block 1646 (which includes the information from the first block 1644), as well as the additional information about the second purchase order from the second order, including the second buyer ID and the second quantity (e.g., “Q2”). As discussed herein, the information from the second block 1646 may be reproduced exactly, or as a hash or other compressed format.

Throughout the product campaign and after the product campaign is complete, the blockchain ledger 1642 may be reviewed to determine terms and conditions of the smart contract, buyers, total quantities, and so forth. Because the blockchain ledger 1642 is publicly available, any disputes in the contents of the smart contract may be easily resolved. This may improve the ease of use and efficiency of contract enforcement over conventional mechanisms.

As discussed herein, the information from the purchase orders recorded in the blockchain ledger 1642 may be aggregated using an aggregator. In some embodiments the aggregator may aggregate the first quantity with each additional purchase quantity added to the blockchain ledger. In some embodiments, the aggregator and/or the campaign manager may compare the aggregated purchase quantity with the MOQ or other execution conditions to determine if the smart contract should be executed.

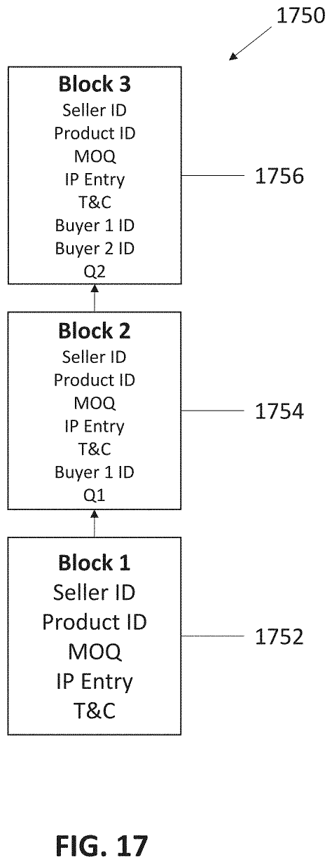

FIG. 17 is a representation of a blockchain ledger 1750 of a product campaign, according to at least one embodiment of the present disclosure. In the embodiment shown in FIG. 17, a first block 1752 of the blockchain ledger 1750 may include the initial product information provided by the seller, such as the seller ID, the product ID, the MOQ, an IP protection entry, and the initial terms and conditions of the smart contract. The IP protection entry may include a product description, such as a prose description and/or an image or a series of images of the product. In some embodiments, the IP protection entry may include a hash of an image, which may help to reduce the size of the first block 1752.

In some embodiments, the first block 1752 may include a timestamp of the time the first block 1752 was created. If a second seller attempts to sell a product that utilizes the same product description, the IP entry stored in the first block 1752 accompanied by the timestamp may help to show who sold the product first. For example, if the timestamp of the hash is earlier than the second seller's attempt to sell the product, then the campaign manager may know that the first seller sold the product first. The campaign manager may then take down the second seller's product. This may greatly improve the efficiency of enforcement of IP policies by the campaign manager by reducing or preventing human oversight of IP enforcement systems.

When a first buyer submits a first purchase order, the campaign manager may prepare a second block 1754 of the blockchain ledger 1750. The second block 1754 may include all of the information from the first block 1752 (or a hash of the information), as well as the details of the first purchase order, such as the first buyer's ID and a first quantity.

When a second buyer submits a second purchase order, the campaign manager may prepare a third block 1756 of the blockchain ledger 1750. The third block 1756 may include all of the information from the second block 1752 (or a hash of the information), as well as the details of the second purchase order, such as the second buyer's ID and a second quantity. In some embodiments, the second quantity may be the number of units in the second purchase order. In some embodiments, the second quantity may be an aggregated total of units purchased by both the first buyer and the second buyer. In some embodiments, the third block 1756 may include both the number of units in the second purchase order as well as the aggregated total of units of all the buyers from the product campaign.

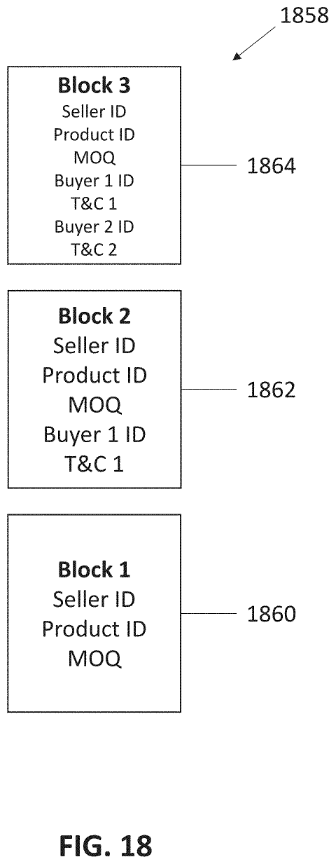

FIG. 18 is a representation of a blockchain ledger 1858 of a product campaign, according to at least one embodiment of the present disclosure. A first block 1860 of the blockchain ledger 1858 may include the initial product information, including the seller ID, the product ID, the MOQ, and any other product information. After a first buyer submits a first purchase order, a second block 1862 may be recorded on the blockchain ledger 1858. The second block 1862 may include all the information from the first block 1860 and include information about the first buyer and the details of the first purchase order. For example, the second block 1862 may include a first set of terms and conditions. The first set of the terms and conditions may be related to the first purchase order, and include information such as pricing, quantity, delivery, and other terms and conditions.

After a second buyer submits a second purchase order, a third block 1864 may be recorded to the blockchain ledger 1858. The third block 1864 may include all of the information from the second block 1862, as well as information about the second buyer and the second purchase order. For example, the third block 1864 may include second terms and conditions. The second terms and conditions may be specific to the second purchase order, and may include information such as pricing, quantity, delivery, and other terms and conditions. In this manner, and as discussed in further detail herein, a smart contract may be developed and maintained in the blockchain ledger 1858. The smart contract may be developed over time based on the initial information provided by the seller, terms and conditions from purchase orders, and other updates to the blockchain ledger 1858.

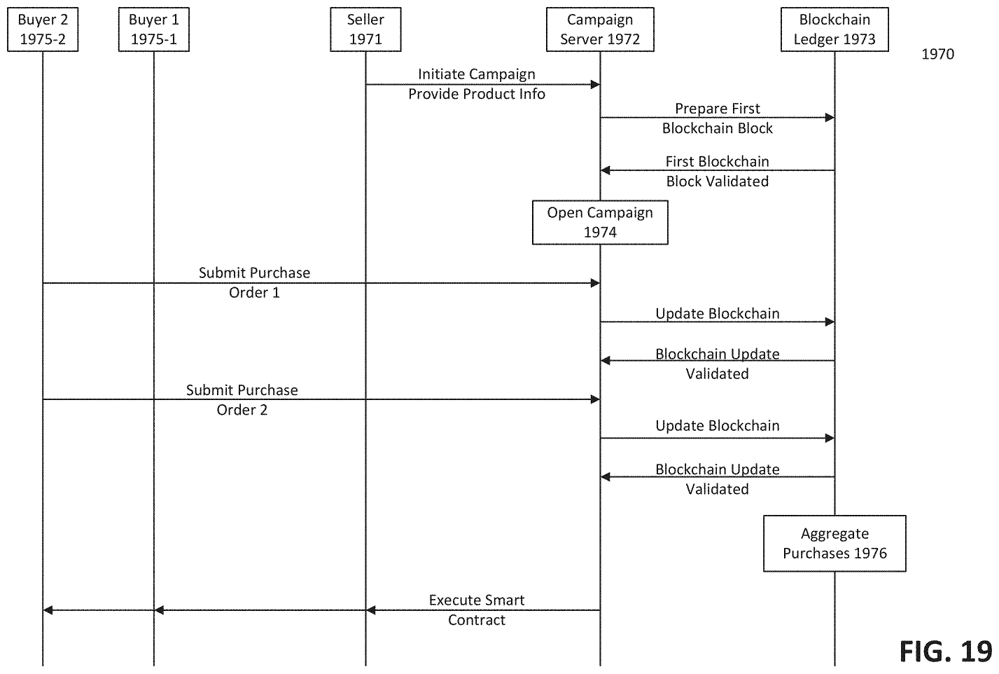

FIG. 19 is a campaign flow diagram 1970 of a product campaign, according to at least one embodiment of the present disclosure. At the start of the product campaign, a seller 1971 may initiate a product campaign with a campaign server 1972. While initiating the product campaign, the seller 1971 may provide product information to the campaign server 1972. The campaign server 1972 may prepare the first blockchain block on a blockchain ledger 1973. The blockchain ledger 1973 may validate (e.g., show or verify that the block was recorded in the blockchain ledger 1973) the first blockchain block with the campaign server, and the campaign server may open the product campaign 1974.

After the campaign is opened, a first buyer 1975-1 may submit a first purchase order to the campaign server. As discussed herein, the first purchase order may include information about the first buyer, terms and conditions for the first purchase order, a product quantity, and so forth. The campaign server 1972 may receive the first purchase order and update the blockchain ledger 1973. The blockchain ledger 1973 may then validate the blockchain update with the first purchase order. During the product campaign, a second buyer 1975-2 may submit a second purchase order to the campaign server 1972. The campaign server 1972 may then update the blockchain ledger 1973, which may validate the blockchain update to the campaign server 1972. In some embodiments, either during the campaign or after the campaign has closed, the blockchain ledger 1973 may aggregate the purchase orders 1976. After the purchase orders are aggregated, the campaign server 1972 may execute the smart contract with the seller 1971 and each of the buyers, including the first buyer 1975-1 and the second buyer 1975-2. Put another way, the campaign server 1972 may instruct the seller 1971 to manufacture and/or distribute the product and the buyers to pay for and receive the product.

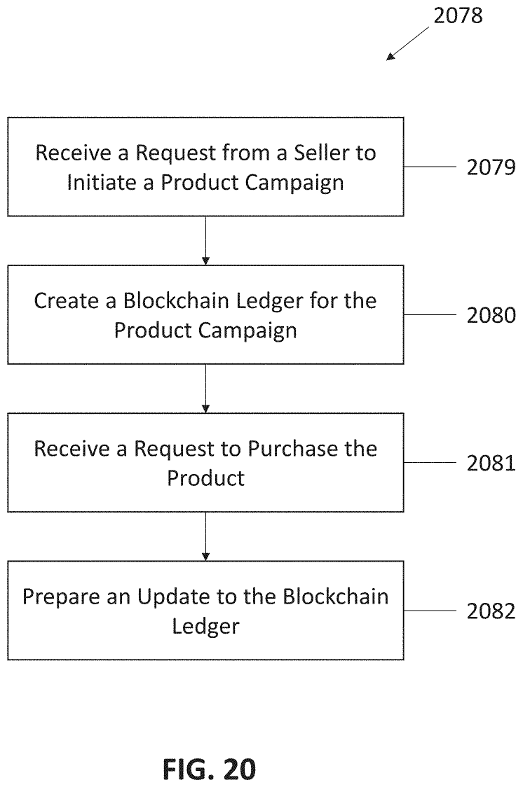

FIGS. 20-22, the corresponding text, and the examples provide a number of different methods, systems, devices, and non-transitory computer-readable media of the product tracking system 1400 shown in FIG. 14. In addition to the foregoing, one or more embodiments can also be described in terms of flowcharts comprising acts for accomplishing a particular result, as shown in FIGS. 20-22. Each of FIGS. 20-22 may be performed with more or fewer acts. Further, the acts may be performed in differing orders. Additionally, the acts described herein may be repeated or performed in parallel with one another or parallel with different instances of the same or similar acts.

As mentioned, FIG. 20 illustrates a flowchart of a series of acts 2078 for generating a smart contract in accordance with one or more embodiments. While FIG. 20 illustrates acts according to one embodiment, alternative embodiments may omit, add to, reorder, and/or modify any of the acts shown in FIG. 20. The acts of FIG. 20 can be performed as part of a method. Alternatively, a non-transitory computer-readable medium can comprise instructions that, when executed by one or more processors, cause a computing device to perform the acts of FIG. 20. In some embodiments, a system can perform the acts of FIG. 20.

In accordance with embodiments of the present disclosure, the method 2078 includes receiving a request for a seller to initiate a product campaign at 2079. In some embodiments, receiving the request may include receiving product information from the seller about the product. In some embodiments, the product information may include IP protection information, such as a description of the product, an image of the product, a hash of an image of the product, or other IP protection information.

In some embodiments, a campaign manager may create a blockchain ledger for the product campaign at 2080. The blockchain ledger includes a smart contract having terms and conditions for the product campaign and the terms and conditions may include a minimum order quantity. The campaign manager may receive a request from a first buyer of a plurality of buyers to purchase the product at 2081. The first request may include a first quantity. In some embodiments, the first quantity may be less than the MOQ.

The campaign manager may prepare an update to the blockchain ledger based on the first request at 2082. The first update may contractually bind the first buyer to perform the first request and may bind the seller to manufacture and/or distribute the product according to the terms and conditions of the smart contract.

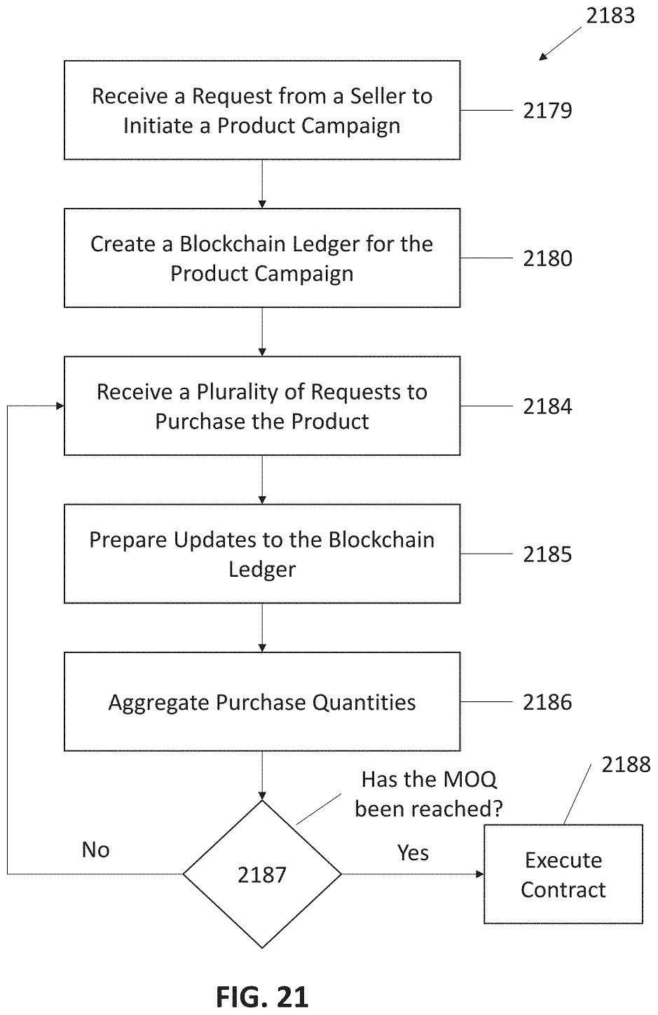

As mentioned, FIG. 21 illustrates a flowchart of a series of acts 2183 for generating a smart contract in accordance with one or more embodiments. While FIG. 21 illustrates acts according to one embodiment, alternative embodiments may omit, add to, reorder, and/or modify any of the acts shown in FIG. 21. The acts of FIG. 21 can be performed as part of a method. Alternatively, a non-transitory computer-readable medium can comprise instructions that, when executed by one or more processors, cause a computing device to perform the acts of FIG. 21. In some embodiments, a system can perform the acts of FIG. 21.

In accordance with embodiments of the present disclosure, the method 2183 includes receiving a request for a seller to initiate a product campaign at 2179. In some embodiments, receiving the request may include receiving product information from the seller about the product. In some embodiments, the product information may include IP protection information, such as a description of the product, an image of the product, a hash of an image of the product, or other IP protection information.

In some embodiments, a campaign manager may create a blockchain ledger for the product campaign at 2180. The blockchain ledger includes a smart contract having terms and conditions for the product campaign and the terms and conditions may include a minimum order quantity. The campaign manager may receive a plurality of requests from a plurality of buyers to purchase the product at 2184. The campaign manager may prepare updates to the blockchain ledger based on the first request at 2185. In some embodiments, the plurality of requests may be additional requests. For example, the campaign manager may receive a first request from a first buyer, and a plurality of additional requests from a plurality of additional buyers. In this manner, the updates to the blockchain ledger may be additional updates to the blockchain ledger.

In some embodiments, the method 2183 may further include aggregating the purchase quantities at 2186. For example, an aggregator may prepare a sum or total quantity of the first quantity and each additional quantity from each of the purchase orders from the blockchain ledger. The campaign manager may determine at 2187 whether the MOQ, or any other execution condition, has been met. If the MOQ or other execution condition has not been met, then the campaign manager may continue to receive purchase orders or otherwise wait until the MOQ or other execution condition has been met. In some embodiments, if a campaign period has ended and the MOQ has not been met, then the smart contract may not be executed, and the seller may not be obligated manufacture and/or distribute the product and the buyer may not be obligated to purchase and receive the product. If the MOQ has been reached, then the smart contract may be executed at 2188. In some embodiments, the method may include instructing the seller and the buyer to execute the smart contract. For example, the campaign manager may instruct the seller and the buyer to execute the smart contract.

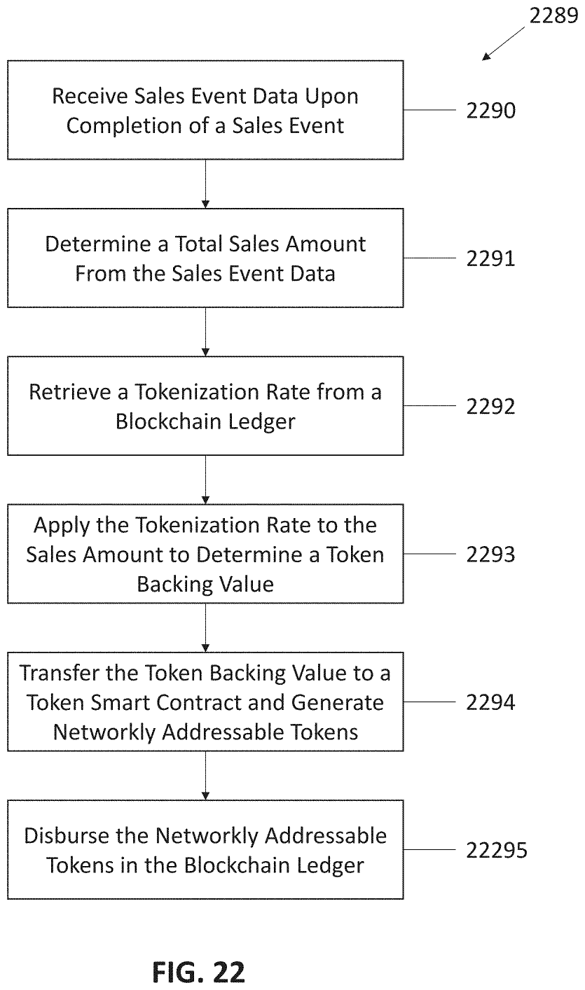

As mentioned, FIG. 22 illustrates a flowchart of a series of acts 2289 for generating a smart contract in accordance with one or more embodiments. While FIG. 22 illustrates acts according to one embodiment, alternative embodiments may omit, add to, reorder, and/or modify any of the acts shown in FIG. 22. The acts of FIG. 22 can be performed as part of a method. Alternatively, a non-transitory computer-readable medium can comprise instructions that, when executed by one or more processors, cause a computing device to perform the acts of FIG. 22. In some embodiments, a system can perform the acts of FIG. 22.

As discussed herein, smart contracts are used to track the sales of products between sellers and buyers. The smart contracts may be compiled into blockchains to provide an immutable record of the sales that can be reviewed as needed. Tokens are dedicated currency that can be used on the platform in place of traditional currency. The use of tokens may help streamline the buying and selling process on the platform.

Tokens can be distributed to buyers through the platform. Buyers use the tokens to indicate their desire to purchase a certain amount of a seller's product, by sending a specified amount of tokens to the network address of the product. The transfer of the tokens represents the buyer's intention to purchase the certain product without having to perform an actual monetary transfer, which may have associated fees.

In this manner, the purchases of a product are continually aggregated, recorded, and associated with the network address of the product to create the immutable record on the blockchain ledger. The smart contract, such as the smart contract 1528 of FIG. 15, monitors the network address of the product and when a new transaction has occurred, the smart contract collects a hash value representative of the transaction and stores it in the contract. The smart contract continues to grow and expand as more transactions for the product occur. Once the sale of the product has closed, the network address is closed, thereby creating a final, immutable record of the transactions involving that product.

The use of the smart contracts and tokens in this blockchain manner may reduce the resources required to track product sales, in comparison to typical sales tracking. Instead of tracking seller sales and buyer purchases on an individual basis, the entire record of a sales event may be stored in blockchains and accessible to any user as needed. The platform can provide a reader or explorer to allow users to retrieve information from the blockchains. Additionally, the platform may include tools to convert hash values to clear text. However, this may be limited in some cases to prevent participants from gaining an unfair market advantage. For example, a seller exploring a sales record for a product may be able to view the clear text identification of each buyer that purchased a product. Whereas, a buyer viewing the same sales record may be able to view clear text identification of the seller and their own purchase, but the purchases by or identification of other buyers may be represented by a hash value.

The tokens may have an actual value that is backed by the sales through the platform. For example, upon completion of the sale, a portion of the proceeds can be converted into tokens and added to the smart contract. These tokens can then be distributed amongst the participants according to the terms of the smart contract, such as transferring the tokens to the seller upon completion of sales with buyers or transferred to buyers if a seller fails to deliver the product as contracted.

The tokens can be stored and used by the users on the platform or can be cashed-in. When Tokens are cashed in, they are returned back to the smart contract from which they were earned/derived or removed from circulation. The tokens may be converted to currency at a predetermined rate associated with the smart contract, such as at a predetermined discount. For example, the smart contract may specify a redemption discount of 3%, meaning that the exchange of tokens into currency results in 97% of the total tokens exchanged is converted to currency that is provided back to the exchanging user and 3% is retained by the platform. This redemption discount helps to ensure that the value of the Tokens continues to grow over time.

The value of the tokens can be determined on a regular basis, such as daily, weekly, monthly, yearly, or any period in between. The value is based on the total currency value deposited by the users (e.g., sellers and/or buyers) into a network token contract, divided by the total number of tokens held by users. In this manner, the tokens are always backed by an actual cash value. Additionally, as the value of tokens increases, there may be times when fractional amounts of a token are used to perform transactions and the platform and tokens are enabled to do so.

The tokens created upon completion of a sales event may also serve to memorialize the sales event and include information of the sales event included or encoded therein. The records of the sales event may be valuable to sellers and/or buyers who are trying to achieve certain sustainability goals. Similarly, a non-fungible token(s) (NFT) may be created to memorialize and record a sales event and may be distributed to the participants as a record of their participation in the event. The NFT is an immutable record that can be provided to an entity or government as proof of participation in the sale and relevant details of the sale. In some embodiments, the platform may measure sustainability impact by capturing and storing on the blockchain ledger data about the products that have been cancelled. This may allow the buyer to measure not only the financial impact of not producing and accumulating otherwise wasteful products inventory and dead stock, but also other impacts, such as ecological, carbon footprint impacts, and so forth.

In accordance with embodiments of the present disclosure, the method 2289 may include receiving sales event data upon completion of a sales event at 2290. The sales event may include a plurality of products or a plurality of product campaigns. The sales event may include event transactional data that includes a price for each product of the plurality of products and a sale quantity for each product of the plurality of products. An aggregator, such as the aggregator 1540 of FIG. 15, may determine a total sales amount from the sales event data at 2291. The total sales amount may be based on the price of each product and the sale quantity of each product.

In some embodiments, a token manager may retrieve from a blockchain ledger, a tokenization rate for the sales event at 2292. The token manager may apply the tokenization rate to the sales amount to determine a token backing value at 2293. The token manager may transfer the token backing value to a token smart contract and generate a number of tokens based on the tokenization rate at 2294. The token manager may then disburse the tokens to participants of the sales event at 2295.

Embodiments of the present disclosure may comprise or utilize a special purpose or general-purpose computer including computer hardware, such as, for example, one or more processors and system memory, as discussed in greater detail below. Embodiments within the scope of the present disclosure also include physical and other computer-readable media for carrying or storing computer-executable instructions and/or data structures. In particular, one or more of the processes described herein may be implemented at least in part as instructions embodied in a non-transitory computer-readable medium and executable by one or more computing devices (e.g., any of the media content access devices described herein). In general, a processor (e.g., a microprocessor) receives instructions, from a non-transitory computer-readable medium, (e.g., memory), and executes those instructions, thereby performing one or more processes, including one or more of the processes described herein.

Computer-readable media can be any available media that can be accessed by a general purpose or special purpose computer system. Computer-readable media that store computer-executable instructions are non-transitory computer-readable storage media (devices). Computer-readable media that carry computer-executable instructions are transmission media. Thus, by way of example, and not limitation, embodiments of the disclosure can comprise at least two distinctly different kinds of computer-readable media: non-transitory computer-readable storage media (devices) and transmission media.

Non-transitory computer-readable storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to non-transitory computer-readable storage media (devices) (or vice versa). For example, computer-executable instructions or data structures received over a network or data link can be buffered in RAM within a network interface module (e.g., a “NIC”), and then eventually transferred to computer system RAM and/or to less volatile computer storage media (devices) at a computer system. Thus, it should be understood that non-transitory computer-readable storage media (devices) can be included in computer system components that also (or even primarily) utilize transmission media.

Computer-executable instructions comprise, for example, instructions and data which, when executed by a processor, cause a general-purpose computer, special purpose computer, or special purpose processing device to perform a certain function or group of functions. In some embodiments, computer-executable instructions are executed by a general-purpose computer to turn the general-purpose computer into a special purpose computer implementing elements of the disclosure. The computer-executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the disclosure may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. The disclosure may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Embodiments of the present disclosure can also be implemented in cloud computing environments. As used herein, the term “cloud computing” refers to a model for enabling on-demand network access to a shared pool of configurable computing resources. For example, cloud computing can be employed in the marketplace to offer ubiquitous and convenient on-demand access to the shared pool of configurable computing resources. The shared pool of configurable computing resources can be rapidly provisioned via virtualization and released with low management effort or service provider interaction, and then scaled accordingly.

A cloud-computing model can be composed of various characteristics such as, for example, on-demand self-service, broad network access, resource pooling, rapid elasticity, measured service, and so forth. A cloud-computing model can also expose various service models, such as, for example, Software as a Service (“SaaS”), Platform as a Service (“PaaS”), and Infrastructure as a Service (“IaaS”). A cloud-computing model can also be deployed using different deployment models such as private cloud, community cloud, public cloud, hybrid cloud, and so forth. In addition, as used herein, the term “cloud-computing environment” refers to an environment in which cloud computing is employed.

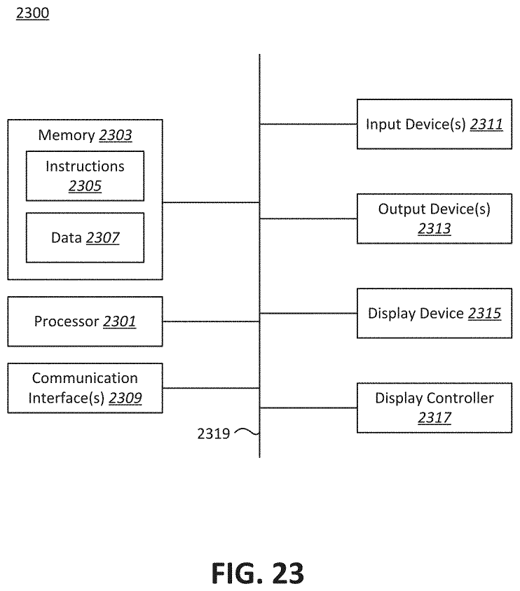

FIG. 23 illustrates a block diagram of an example computing device 2300 or computing system that may be configured to perform one or more of the processes described above. One will appreciate that one or more computing devices, such as the computing device 2300 may represent the computing devices and systems described above (e.g., the campaign manager). In one or more embodiments, the computing device 2300 may be a mobile device (e.g., a mobile telephone, a smartphone, a PDA, a tablet, a laptop, a camera, a tracker, a watch, a wearable device, etc.). In some embodiments, the computing device 2300 may be a non-mobile device (e.g., a desktop computer or another type of client device). Further, the computing device 2300 may be a server device that includes cloud-based processing and storage capabilities.

As shown in FIG. 23, the computing device 2300 can include one or more processor(s) 2302, memory 2304, a storage device 2306, input/output interfaces 2308 (or “I/O interfaces 2308”), and a communication interface 2310, which may be communicatively coupled by way of a communication infrastructure (e.g., bus 2312). While the computing device 2300 is shown in FIG. 23, the components illustrated in FIG. 23 are not intended to be limiting. Additional or alternative components may be used in other embodiments. Furthermore, in certain embodiments, the computing device 2300 includes fewer components than those shown in FIG. 23. Components of the computing device 2300 shown in FIG. 23 will now be described in additional detail.

In particular embodiments, the processor(s) 2302 includes hardware for executing instructions, such as those making up a computer program. As an example, and not by way of limitation, to execute instructions, the processor(s) 2302 may retrieve (or fetch) the instructions from an internal register, an internal cache, memory 2304, or a storage device 2306 and decode and execute them.

The computing device 2300 includes memory 2304, which is coupled to the processor(s) 2302. The memory 2304 may be used for storing data, metadata, and programs for execution by the processor(s). The memory 2304 may include one or more of volatile and non-volatile memories, such as Random-Access Memory (“RAM”), Read-Only Memory (“ROM”), a solid-state disk (“SSD”), Flash, Phase Change Memory (“PCM”), or other types of data storage. The memory 2304 may be internal or distributed memory.

The computing device 2300 includes a storage device 2306 includes storage for storing data or instructions. As an example, and not by way of limitation, the storage device 2306 can include a non-transitory storage medium described above. The storage device 2306 may include a hard disk drive (HDD), flash memory, a Universal Serial Bus (USB) drive or a combination these or other storage devices.

As shown, the computing device 2300 includes one or more I/O interfaces 2308, which are provided to allow a user to provide input to (such as user strokes), receive output from, and otherwise transfer data to and from the computing device 2300. These I/O interfaces 2308 may include a mouse, keypad or a keyboard, a touch screen, camera, optical scanner, network interface, modem, other known I/O devices or a combination of such I/O interfaces 2308. The touch screen may be activated with a stylus or a finger.

The I/O interfaces 2308 may include one or more devices for presenting output to a user, including, but not limited to, a graphics engine, a display (e.g., a display screen), one or more output drivers (e.g., display drivers), one or more audio speakers, and one or more audio drivers. In certain embodiments, I/O interfaces 2308 are configured to provide graphical data to a display for presentation to a user. The graphical data may be representative of one or more graphical user interfaces and/or any other graphical content as may serve a particular implementation.

The computing device 2300 can further include a communication interface 2310. The communication interface 2310 can include hardware, software, or both. The communication interface 2310 provides one or more interfaces for communication (such as, for example, packet-based communication) between the computing device and one or more other computing devices or one or more networks. As an example, and not by way of limitation, communication interface 2310 may include a network interface controller (NIC) or network adapter for communicating with an Ethernet or other wire-based network or a wireless NIC (WNIC) or wireless adapter for communicating with a wireless network, such as a WI-FI. The computing device 2300 can further include a bus 2312. The bus 2312 can include hardware, software, or both that connects components of computing device 2300 to each other.

In the foregoing specification, the invention has been described with reference to specific example embodiments thereof. Various embodiments and aspects of the invention(s) are described with reference to details discussed herein, and the accompanying drawings illustrate the various embodiments. The description above and drawings are illustrative of the invention and are not to be construed as limiting the invention. Numerous specific details are described to provide a thorough understanding of various embodiments of the present disclosure.

The present disclosure may be embodied in other specific forms without departing from its spirit or essential characteristics. The described embodiments are to be considered in all respects only as illustrative and not restrictive. For example, the methods described herein may be performed with less or more steps/acts or the steps/acts may be performed in differing orders. Additionally, the steps/acts described herein may be repeated or performed in parallel to one another or in parallel to different instances of the same or similar steps/acts. The scope of the invention is, therefore, indicated by the appended claims rather than by the foregoing description. All changes that come within the meaning and range of equivalency of the claims are to be embraced within their scope.

What is claimed is:

1. A computer-implemented method comprising:
receiving a request from a seller to initiate a product campaign to manufacture and distribute a product;
creating a blockchain ledger for the product campaign, the blockchain ledger including a smart contract having terms and conditions for the product campaign, the terms and conditions including a minimum order quantity;
receiving a first request of a plurality of requests from a first buyer of a plurality of buyers to purchase the product, wherein the first request includes a first purchase quantity; and
preparing a first update to the blockchain ledger based on the first request, wherein the first update contractually binds the first buyer to perform the first request and contractually binds the seller to distribute the product if the minimum order quantity is met.

2. The method of claim 1, further comprising:
receiving additional requests of the plurality of requests to purchase the product, each additional request including an additional purchase quantity; and
preparing additional updates to the blockchain ledger for each additional request.

3. The method of claim 2, further comprising:
aggregating the first purchase quantity with each additional purchase quantity for an aggregated purchase quantity; and
if the aggregated purchase quantity is greater than the minimum order quantity, instructing the seller to distribute the product.

4. The method of claim 3, wherein the first purchase quantity and each additional purchase quantity are less than the minimum order quantity.

5. The method of claim 3, wherein instructing the seller to manufacture and distribute the product occurs after a campaign period has ended.

6. The method of claim 3, wherein aggregating the first purchase quantity with each additional purchase quantity includes aggregating based on the first update and the additional updates to the blockchain ledger.

7. The method of claim 2, wherein, if the aggregated purchase quantity is less than the minimum order quantity, the seller is not obligated to manufacture and distribute the product.

8. The method of claim 1, wherein creating the blockchain ledger for the product campaign includes creating an IP protection entry in the blockchain ledger, the IP protection entry including product information.

9. The method of claim 8, wherein the product information includes a hash of an image.

10. A computing system, comprising:
one or more processors;
memory including instructions which, when accessed by the one or more processors, cause the one or more processors to:
receive a request from a seller to initiate a product campaign to manufacture and distribute a product;
create a blockchain ledger for the product campaign, the blockchain ledger including a smart contract having terms and conditions for the product campaign, the terms and conditions including a minimum order quantity;
receive a first request of a plurality of requests from a first buyer of a plurality of buyers to purchase the product, wherein the first request includes a first purchase quantity; and
prepare a first update to the blockchain ledger based on the first request, wherein the first update contractually binds the first buyer to perform the first request and contractually binds the seller to distribute the product if the minimum order quantity is met.

11. The computing system of claim 10, wherein the memory includes further instructions which cause the one or more processors to:
receive additional requests of the plurality of requests to purchase the product, each additional request including an additional purchase quantity; and
prepare additional updates to the blockchain ledger for each additional request.

12. The computing system of claim 11, wherein the memory includes further instructions which cause the one or more processors to:
aggregate the first purchase quantity with each additional purchase quantity for an aggregated purchase quantity; and
if the aggregated purchase quantity is greater than the minimum order quantity, instruct the seller to distribute the product.

13. The computing system of claim 12, wherein the first purchase quantity and each additional purchase quantity are less than the minimum order quantity.

14. The computing system of claim 12, wherein instructing the seller to manufacture and distribute the product occurs after a campaign period has ended.

15. The computing system of claim 12, wherein aggregating the first purchase quantity with each additional purchase quantity includes aggregating based on the first update and the additional updates to the blockchain ledger.

16. The computing system of claim 11, wherein, if the aggregated purchase quantity is less than the minimum order quantity, the seller is not obligated to manufacture and distribute the product.

17. The computing system of claim 10, wherein creating the blockchain ledger for the product campaign includes creating an IP protection entry in the blockchain ledger, the IP protection entry including product information.

18. The computing system of claim 17, wherein the product information includes a hash of an image.

19. A method, comprising:
receiving sales event data upon completion of a sales event of a plurality of products, the sales event including event transactional data including a price for each product of the plurality of products and a sale quantity for each product of the plurality of products;
determining a total sales amount from the sales event data, the total sales amount being based the price of each product and the sale quantity of each product;
retrieving from a blockchain ledger, a tokenization rate for the sales event;
applying the tokenization rate to the sales amount to determine a token backing value;
transferring the token backing value to a token smart contract and generating a number of tokens based on the tokenization rate; and
disbursing the tokens to participants of the sales event.

20. The method of claim 19, further comprising:
recoding the disbursed tokens in the blockchain ledger; and
redeeming a portion of the tokens at a predetermined rate that ensures the remaining tokens are backed by a per token value in the token smart contract that is greater than a per token value in the token smart contract prior to redemption of the portion of the tokens.
